(19) United States
(12) Patent Application Publication
(10) Pub. No.: US 2018/0314188 A1
(43) Pub. Date: Nov. 1, 2018

(54) ELECTROPHOTOGRAPHIC PHOTOSENSITIVE MEMBER, PROCESS CARTRIDGE AND ELECTROPHOTOGRAPHIC APPARATUS

(71) Applicant: CANON KABUSHIKI KAISHA, Tokyo (JP)

(72) Inventors: Eileen Takeuchi, Toride-shi (JP); Kumiko Takizawa, Saitama-shi (JP); Ikuyo Kuroiwa, Tokyo (JP); Tsuyoshi Shimada, Toride-shi (JP); Wataru Kitamura, Abiko-shi (JP)

(21) Appl. No.: 15/958,464

(22) Filed: Apr. 20, 2018

(30) Foreign Application Priority Data
Apr. 27, 2017 (JP) 2017-088712

(51) Int. Cl. G03G 15/00

(52) U.S. Cl. CPC G03G 15/0867; G03G 15/0808; G03G 15/04072; G03G 15/5008

(57) ABSTRACT

An electrophotographic photosensitive member, wherein fluctuation in potential is suppressed, and the occurrence of black spots is suppressed even if the electrophotographic photosensitive member is repeatedly used for a long period of time is provided. A process cartridge that is equipped with the electrophotographic photosensitive member and an electrophotographic apparatus that is equipped with the process cartridge are provided. An electrophotographic photosensitive member, wherein an undercoat layer of the electrophotographic photosensitive member contains an aluminum oxide particle that is surface-treated in a specific amount using a specific compound.

### BACKGROUND OF THE INVENTION

### Field of the Invention

The present invention relates to an electrophotographic photosensitive member, a process cartridge having the electrophotographic photosensitive member, and an electrophotographic apparatus.

### Description of the Related Art

Electrophotographic photosensitive members having an undercoat layer and a photosensitive layer on an electro-conductive support are widely used as electrophotographic photosensitive members that are used in electrophotographic apparatuses. The undercoat layer bears a role of inhibiting charges from being injected from the support, and transporting electrons generated in the photosensitive layer, in addition to roles of hiding defects of the support and suppressing interference fringes.

A metal oxide particle that is used in the undercoat layer is surface-treated with the use of a coupling agent, in order to suppress black-dot image defects (hereinafter also referred to as black spot) which are caused by charge injection from the support to the photosensitive layer side.

However, in the undercoat layer that uses the metal oxide particle which is surface-treated with the use of the coupling agent, the resistance of the undercoat layer increases, and fluctuation in potential (fluctuation in the light portion potential, and the like) at the time of repeated use tends to become remarkable.

For this reason, as for a technology for suppressing the fluctuation in the light portion potential, Japanese Patent Application Laid-Open No. 2010-152099 discloses a technology for filtering an undercoat layer coating liquid before the coating process to remove a coarse secondary agglomerated particle contained in the coating liquid for the undercoat layer, and also controlling a rate of change in a ratio of the weight of the metal oxide fine particle to the weight of the binder resin, to a particular region.

In addition, Japanese Patent Application Laid-Open No. 2004-191868 discloses a technology for making the undercoat layer contain a metal oxide particle that is surface-treated with a silane compound which has a substituted or unsubstituted amino group as a coupling agent.

### SUMMARY OF THE INVENTION

However, if an aluminum oxide which is surface-treated with the silane coupling agent is used as the metal oxide particle to be contained in the undercoat layer, the fluctuation in the potential at the time of repeated use tends to easily occur depending on the amount used for surface treatment, although there is a suppressive effect on the occurrence of black spots.

In addition, the present inventors have made a further investigation, and as a result, have made the aluminum oxide particle contained in the undercoat layer, which has been surface-treated with a silane coupling agent that has an alkyl group having a few carbon atoms, for the purpose of suppressing the fluctuation in the potential at the time of repeated use for a long period of time. However, in that case, the aluminum oxide particles were agglomerated, which tended to easily cause image defects such as black spots, and it was found that it was difficult to achieve both of the suppression of the fluctuation in the potential and the suppression of the occurrence of black spots.

An object of the present invention is to provide an electrophotographic photosensitive member wherein fluctuation in potential is suppressed even if the electrophotographic photosensitive member is repeatedly used for a long period of time and the occurrence of black spots is suppressed even if the electrophotographic photosensitive member is repeatedly used for a long period of time.

In addition, another object of the present invention is to provide a process cartridge that is equipped with the above described electrophotographic photosensitive member, and an electrophotographic apparatus that is equipped with the process cartridge.

The above described object is achieved by the following present invention.

The present invention relates to an electrophotographic photosensitive member having a support, an undercoat layer and a photosensitive layer in this order, wherein the undercoat layer contains a binder resin, and an aluminum oxide particle which is surface-treated with a compound represented by the following formula (1),

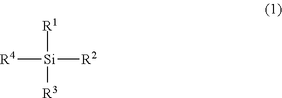

wherein R¹ to R³ each independently represent an alkoxy group or an alkyl group, provided that at least two of R¹ to R³ are alkoxy groups, and R⁴ is an alkyl group having n carbon atoms (6≤n≤18), and wherein
when an amount of aluminum atoms in the surface-treated aluminum oxide particle is represented by M_{Al} and an amount of silicon atoms derived from the compound represented by the formula (1) is represented by M_{Si}, a product of an amount X used for surface treatment defined by X=(M_{Si}/M_{Al})×100 (% by mass) and a number n of carbon atoms in R⁴ (hereinafter also referred to as X×n) is 10 or more and 330 or less.

The present invention also relates to a process cartridge that integrally supports the above described electrophotographic photosensitive member and at least one unit selected from the group consisting of a charging unit, a developing unit, a transfer unit and a cleaning unit, and is detachably attachable to a main body of the electrophotographic apparatus.

In addition, the present invention relates to an electrophotographic apparatus that includes the above described electrophotographic photosensitive member, a charging unit, an exposing unit, a developing unit and a transfer unit.

As has been described above, according to the present invention, there can be provided an electrophotographic photosensitive member that is excellent in suppressing fluctuation in potential when the electrophotographic photosensitive member is repeatedly used for a long period of time, and suppressing the occurrence of black spots. In addition, according to the present invention, there can be provided a process cartridge having the above described electrophotographic photosensitive member, and an electrophotographic apparatus.

Further features of the present invention will become apparent from the following description of exemplary embodiments with reference to the attached drawings.

### BRIEF DESCRIPTION OF THE DRAWINGS

FIG. 1 is a schematic diagram illustrating an example of the layer constitution of an electrophotographic photosensitive member of the present invention.

FIG. 2 is a figure illustrating an example of a pressure contact shape transfer processing apparatus for forming concave portions on the circumferential face of the electrophotographic photosensitive member.

FIG. 3 is a figure illustrating an example of fitting.

FIG. 4 is a figure illustrating the relationship of a concave portion schematically.

FIG. 5A, FIG. 5B, FIG. 5C, FIG. 5D, FIG. 5E, FIG. 5F, FIG. 5G, FIG. 5H, FIG. 5I and FIG. 5J are figures illustrating examples of the shapes of the openings of the concave portions on the circumferential face of the electrophotographic photosensitive member.

FIG. 6A, FIG. 6B, FIG. 6C, FIG. 6D, FIG. 6E, FIG. 6F, FIG. 6G and FIG. 6H are figures illustrating examples of the shapes of the sections of concave portions on the circumferential face of the electrophotographic photosensitive member when the concave portions are viewed from a circumferential direction.

FIG. 7 is a figure illustrating an example of a polisher including a polishing sheet.

FIG. 8 is a figure illustrating an example of the schematic constitution of a process cartridge equipped with the electrophotographic photosensitive member of the present invention, and an electrophotographic apparatus including the process cartridge.

FIG. 9A is a top view illustrating a mold used in Examples of manufacturing electrophotographic photosensitive members. FIG. 9B is a B-B sectional view of a convex portion on the mold illustrated in FIG. 9A. FIG. 9C is a C-C sectional view of the convex portion on the mold illustrated in FIG. 9A.

FIG. 10 is a figure illustrating an example of the power spectrum of the substrate of the electrophotographic photosensitive member of the present invention.

FIG. 11 is a figure illustrating the relative cumulative frequency of the data group illustrated in FIG. 10.

### DESCRIPTION OF THE EMBODIMENTS

Preferred embodiments of the present invention will now be described in detail in accordance with the accompanying drawings.

The present invention relates to an electrophotographic photosensitive member having a support, an undercoat layer and a photosensitive layer in this order, wherein the undercoat layer contains a binder resin, and an aluminum oxide particle which is surface-treated with a compound represented by the following formula (1),

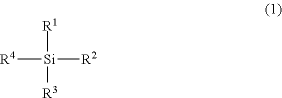

wherein R¹ to R³ each independently represent an alkoxy group or an alkyl group, provided that at least two of R¹ to R³ are alkoxy groups, and R⁴ is an alkyl group having n carbon atoms (6≤n≤18), and wherein when an amount of aluminum atoms in the surface-treated aluminum oxide particle is represented by M_{Al} and an amount of silicon atoms derived from the compound represented by the formula (1) is represented by M_{Si}, a product of an amount X used for surface treatment defined by X=(M_{Si}/M_{Al})×100 (% by mass) and a number n of carbon atoms in R⁴ (X×n) is 10 or more and 330 or less.

The present inventors assume that the reason lies in the following mechanism why the electrophotographic photosensitive member of the present invention is excellent in suppressing the fluctuation in the potential and suppressing the occurrence of black spots, both when the electrophotographic photosensitive member is repeatedly used for a long period of time.

In the present invention, the aluminum oxide particle bears the electro-conductivity of the present undercoat layer. The aluminum oxide particle is covered with a surface treatment agent having a long chain alkyl group, thereby a steric hindrance occurs between the aluminum oxide particles, the aluminum oxide particles resist agglomerating in a dispersion coating liquid, and thereby the occurrence of black spots is suppressed. From the viewpoint that the occurrence of the black spots is further suppressed, it is more preferable that the number n of carbon atoms in R⁴ is 6 or more and 12 or less.

In addition, due to the hydrophobicity which the long-chain alkyl group of the surface treatment agent has, it becomes difficult for moisture to adhere to the aluminum oxide particle, and for the aluminum oxide particles to agglomerate in the dispersion coating liquid, and thereby the occurrence of the black spots is suppressed.

Furthermore, an undercoat layer in which the charges resist accumulating can be obtained by an operation of subjecting the aluminum oxide particle to surface treatment so that the above described X×n becomes 10 or more and 330 or less. It is more preferable that the above described X×n is 10 or more and 220 or less.

Specifically, it can be stated that the long-chain alkyl group contained in the surface treatment agent on the aluminum oxide particle which is contained in the undercoat layer of the electrophotographic photosensitive member of the present invention contributes to stabilization in the dispersion coating liquid due to the steric hindrance of the aluminum oxide particles, and to the expression of hydrophobicity. In addition, it can be stated that a particular amount used for the surface treatment of the aluminum oxide particle contained in the undercoat layer of the electrophotographic photosensitive member of the present invention suppresses the accumulation of charges.

It is considered that thereby such an undercoat layer can be formed as to have the aluminum oxide particles uniformly dispersed therein, have hydrophobicity, and further resist causing the accumulation of charges. It is considered that by forming such an undercoat layer, such an electrophotographic photosensitive member can be obtained as to be excellent both in suppressing the occurrence of the black spots and suppressing the fluctuation in the potential.

Furthermore, in the present invention, the undercoat layer can contain the binder resin and the aluminum oxide particle that is surface-treated with the compound represented by the formula (1), and when a ratio (% by mass) of a mass of the compound represented by the formula (1) to the mass of the aluminum oxide particle is represented by A and the specific surface area (m²/g) of the aluminum oxide particle is represented by B, an amount A/B used for the surface treatment can be 0.020 or more and 0.180 or less.

The mode for carrying out the present invention will be described in detail below.

<Electrophotographic Photosensitive Member>

The electrophotographic photosensitive member according to the present invention is structured to have the undercoat layer and the photosensitive layer in this order. The structure of the electrophotographic photosensitive member according to the present invention can be a structure in which the undercoat layer, a charge generating layer and a charge transport layer are multilayered in this order on the support. An electro-conductive layer may be provided between the charge generating layer and the support, and a protective layer may be provided on the charge transport layer, as needed. Incidentally, in the present invention, the charge generating layer and the charge transport layer are collectively referred to as the “photosensitive layer”.

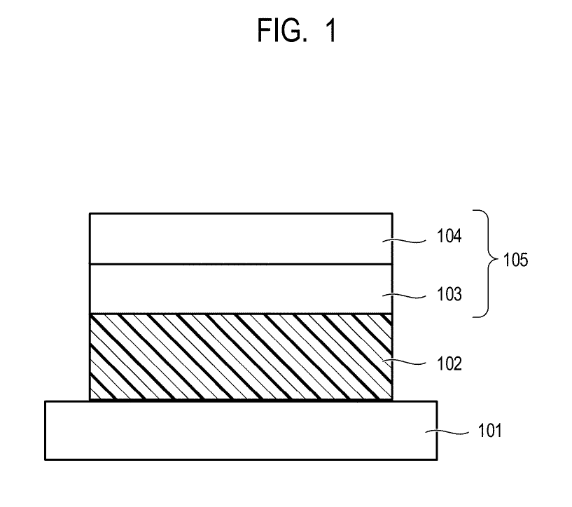

FIG. 1 illustrates one example of the layer constitution of the electrophotographic photosensitive member of the present invention. FIG. 1 illustrates a multilayer type photosensitive layer, in which the undercoat layer 102, the charge generating layer 103 and the charge transport layer 104 are multilayered on the support 101 in FIG. 1. In addition, the charge generating layer 103 and the charge transport layer 104 are collectively referred to as the “photosensitive layer 105”.

The charge transport substance of the present invention is made to be contained in a surface layer. The surface layer in the present invention means the protective layer when the electrophotographic photosensitive member has the protective layer provided thereon, and means the charge transport layer when the protective layer is not provided. In addition, the photosensitive layer may be structured of a single layer type photosensitive layer which contains a charge generating substance and a charge transport substance.

<Support>

In the present invention, the electrophotographic photosensitive member has the support. In the present invention, the support can be an electro-conductive support having electro-conductivity. In addition, shapes of the support include a cylindrical shape, a belt shape and a sheet shape. Among the supports, a cylindrical-shaped support is more preferable. In addition, the surface of the support may be subjected to: electrochemical treatment such as anodic oxidation; blast treatment; cutting treatment; and the like.

The material of the support can be metal, resin, glass and the like.

The metals include aluminum, iron, nickel, copper, gold, stainless steel and alloys thereof. Among the metals, aluminum is preferably used to form a support made from aluminum.

In addition, to the resin or the glass, the electro-conductivity may be imparted, by such treatment as to mix an electro-conductive material into the above material or cover the above material with the electro-conductive material.

<Electro-Conductive Layer>

In the present invention, the electro-conductive layer may be provided on the support. By having the electro-conductive layer provided thereon, the support can conceal a scratch and unevenness on its surface, and control the reflection of light on its surface.

The electro-conductive layer can contain an electro-conductive particle and a resin.

Materials of the electro-conductive particle include metal oxide, metal and carbon black.

The metal oxides include zinc oxide, aluminum oxide, indium oxide, silicon oxide, zirconium oxide, tin oxide, titanium oxide, magnesium oxide, antimony oxide and bismuth oxide. The metals include aluminum, nickel, iron, nichrome, copper, zinc and silver.

Among the materials, it is preferable to use the metal oxide as the electro-conductive particle, and in particular, is more preferable to use titanium oxide, tin oxide or zinc oxide.

When the metal oxide is used as the electro-conductive particle, it is acceptable to treat the surface of the metal oxide with a silane coupling agent or the like, or to dope the metal oxide with an element such as phosphorus or aluminum or with an oxide thereof.

In addition, the electro-conductive particle may have a multilayer constitution that has a core particle and a covering layer which covers the particle. The core particles include titanium oxide, barium sulfate and zinc oxide. The materials of the covering layers include a metal oxide such as tin oxide.

In addition, when the metal oxide is used as the electro-conductive particle, the volume average particle size thereof is preferably 1 nm or larger and 500 nm or smaller, and is more preferably 3 nm or larger and 400 nm or smaller.

The resins include a polyester resin, a polycarbonate resin, a polyvinyl acetal resin, an acrylic resin, a silicone resin, an epoxy resin, a melamine resin, a polyurethane resin, a phenolic resin and an alkyd resin.

In addition, the electro-conductive layer may further contain a concealing agent such as a silicone oil, a resin particle and titanium oxide.

An average film thickness of the electro-conductive layer is preferably 1 μm or more and 50 μm or less, and is particularly preferably 3 μm or more and 40 μm or less.

The electro-conductive layer can be formed by an operation of: preparing a coating liquid for the electro-conductive layer, which contains each of the above-mentioned materials and a solvent; forming a coating film of the liquid on the support; and drying the coating film. Examples of the solvent to be used in the coating liquid include an alcohol-based solvent, a sulfoxide-based solvent, a ketone-based solvent, an ether-based solvent, an ester-based solvent and an aromatic hydrocarbon-based solvent. Dispersion methods for dispersing the electro-conductive particles in the coating liquid for the electro-conductive layer include a method using a paint shaker, a sand mill, a ball mill and a liquid-collision type high-speed dispersing machine.

<Undercoat Layer>

In the present invention, the undercoat layer is provided between the support or the electro-conductive layer, and the photosensitive layer.

The undercoat layer can be formed by an operation of: coating the support or the electro-conductive layer with a coating liquid for the undercoat layer, which contains the aluminum oxide particle that has been surface-treated with the compound represented by the above described formula (1), the binder resin and the solvent, to form a coating film; and drying the coating film.

A general method is used as a method for surface-treating the aluminum oxide particle. The methods include, for instance, a dry method or a wet method.

The dry method is a method of: while stirring the aluminum oxide particles in a high-speed stirrable mixer such as a Henschel mixer, adding an alcoholic aqueous solution, an organic solvent solution or an aqueous solution, each containing a surface treatment agent, into the mixer; uniformly dispersing the aluminum oxide particles in the solution; and drying the aluminum oxide particles.

The wet method is a method of: dispersing the aluminum oxide particles and the surface treatment agent in a solvent, by stirring or by using a sand mill with the use of glass beads and the like; and after the dispersion, removing the solvent by filtration or distillation under a reduced pressure. After the solvent has been removed, the aluminum oxide particles can be baked at 100° C. or higher.

The amount X (% by mass) of the compound of the above described formula (1) used for the surface treatment onto the aluminum oxide can be measured with the use of, for instance, a wavelength dispersion type fluorescent X-ray analyzing apparatus (trade name: Axios) manufactured by Spectris Co., Ltd. As for an object to be measured, the scraped undercoat layer can also be used which has been obtained by peeling the photosensitive layer of the electrophotographic photosensitive member and further the undercoat layer, as needed, and scraping the undercoat layer out. In addition, a powder of the same material as that of the undercoat layer can also be used.

Here, the amount X used for the surface treatment is determined to be a value calculated according to X=(M_{Si}/M_{Al})×100 (% by mass), when M_{Al} represents the amount of the aluminum atoms in the surface-treated aluminum oxide particle, and M_{Si} represents the amount of the silicon atoms derived from the compound represented by the above described formula (1).

Examples of the binder resin to be contained in the undercoat layer include a polyester resin, a polycarbonate resin, a polyvinyl acetal resin, an acrylic resin, an epoxy resin, a melamine resin, a polyurethane resin, a phenolic resin, a polyvinyl phenolic resin, an alkyd resin, a polyvinyl alcohol resin, a polyethylene oxide resin, a polypropylene oxide resin, a polyamide resin, a polyamide acid resin, a polyimide resin, a polyamide-imide resin and a cellulose resin. Among the resins, the polyurethane resin is preferably used.

The polymerizable functional groups which the monomer having a polymerizable functional group has include an isocyanate group, a blocked isocyanate group, a methylol group, an alkylated methylol group, an epoxy group, a metal alkoxide group, a hydroxyl group, an amino group, a carboxyl group, a thiol group, a carboxylic acid anhydride group and a carbon-carbon double bond group. Among the functional groups, the blocked isocyanate group is preferable.

The undercoat layer may further contain an additive, and can contain a known material which includes: a metal powder such as aluminum; an electro-conductive substance such as carbon black; a charge transport substance; a metal chelate compound; and an organometallic compound.

The charge transport substances include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound and a boron-containing compound. It is also acceptable to form the undercoat layer as a cured film, by using a charge transport substance having a polymerizable functional group as the charge transport substance, and copolymerizing the charge transport substance with a monomer having the above-mentioned polymerizable functional group.

Examples of the solvent which is used in the coating liquid for the undercoat layer include organic solvents such as alcohol, sulfoxide, ketone, ether, ester, aliphatic halogenated hydrocarbon and an aromatic compound. In the present invention, it is preferable to use the alcohol-based or ketone-based solvent.

Dispersing methods include methods which use a homogenizer, an ultrasonic dispersing machine, a ball mill, a sand mill, a roll mill, a vibration mill, an attritor and a liquid-collision type high-speed dispersing machine, respectively.

An average film thickness of the undercoat layer is preferably 0.1 μm or more and 10 μm or less, and is more preferably 0.2 μm or more and 5 μm or less.

A mass ratio (M_{P}/M_{BR}) of the above described surface-treated aluminum oxide particle (P) to the above described binder resin (BR) in the undercoat layer can be 1.0/1.0 or more and 3.0/1.0 or less.

The undercoat layer can be formed by an operation of: preparing a coating liquid for the undercoat layer, which contains each of the above-mentioned materials and a solvent; forming a coating film of the liquid on a support or an electro-conductive layer; and drying and/or curing the coating film. Examples of the solvent to be used in the coating liquid include an alcohol-based solvent, a ketone-based solvent, an ether-based solvent, an ester-based solvent and an aromatic hydrocarbon-based solvent.

<Photosensitive Layer>

The photosensitive layer of the electrophotographic photosensitive member is mainly classified into (1) a multilayer type photosensitive layer and (2) a single layer type photosensitive layer. (1) The multilayer type photosensitive layer is a photosensitive layer that has a charge generating layer containing a charge generating substance, and a charge transport layer containing a charge transport substance. (2) The single layer type photosensitive layer is a photosensitive layer that contains both of a charge generating substance and a charge transport substance.

(1) Multilayer Type Photosensitive Layer

The multilayer type photosensitive layer has a charge generating layer and a charge transport layer.

(1-1) Charge Generating Layer

The charge generating layer can contain a charge generating substance and a resin.

The charge generating substances include an azo pigment, a perylene pigment, a polycyclic quinone pigment, an indigo pigment and a phthalocyanine pigment. Among the substances, the azo pigment and the phthalocyanine pigment are preferable. Among the phthalocyanine pigments, an oxytitanium phthalocyanine pigment, a chlorogallium phthalocyanine pigment and a hydroxyl gallium phthalocyanine pigment are preferable.

The content of the charge generating substance in the charge generating layer is preferably 40% by mass or more and 85% by mass or less, and is more preferably 60% by mass or more and 80% by mass or less, based on the total mass of the charge generating layer.

The resins include a polyester resin, a polycarbonate resin, a polyvinyl acetal resin, a polyvinyl butyral resin, an acrylic resin, a silicone resin, an epoxy resin, a melamine resin, a polyurethane resin, a phenolic resin, a polyvinyl alcohol resin, a cellulose resin, a polystyrene resin, a polyvinyl acetate resin and a polyvinyl chloride resin. Among the resins, the polyvinyl butyral resin is more preferable.

In addition, the charge generating layer may further contain additives such as an antioxidant and an ultraviolet absorber. Specific additives include a hindered phenolic compound, a hindered amine compound, a sulfur compound, a phosphorus compound and a benzophenone compound.

An average film thickness of the charge generating layer is preferably 0.1 μm or more and 1 μm or less, and is more preferably 0.15 μM or more and 0.4 μM or less.

The charge generating layer can be formed by an operation of: preparing a coating liquid for the charge generating layer, which contains each of the above-mentioned materials and a solvent; forming a coating film of the liquid on the undercoat layer; and drying the coating film. Examples of the solvent to be used in the coating liquid include an alcohol-based solvent, a sulfoxide-based solvent, a ketone-based solvent, an ether-based solvent, an ester-based solvent and an aromatic hydrocarbon-based solvent.

(1-2) Charge Transport Layer

The charge transport layer can contain a charge transport substance and a resin.

The charge transport substances include a polycyclic aromatic compound, a heterocyclic compound, a hydrazone compound, a styryl compound, an enamine compound, a benzidine compound, a triarylamine compound, and resins having a group derived from these substances. Among the substances, the triarylamine compound and the benzidine compound are preferable.

A content of the charge transport substance in the charge transport layer is preferably 25% by mass or more and 70% by mass or less, and is more preferably 30% by mass or more and 55% by mass or less, based on the total mass of the charge transport layer.

The resins include a polyester resin, a polycarbonate resin, an acrylic resin and a polystyrene resin. Among the resins, the polycarbonate resin and the polyester resin are preferable. A polyarylate resin is particularly preferable as the polyester resin.

A content ratio (mass ratio) of the charge transport substance to the resin is preferably 4:10 to 20:10, and is more preferably 5:10 to 12:10.

In addition, the charge transport layer may contain additives such as an antioxidant, an ultraviolet absorber, a plasticizer, a leveling agent, a lubricity imparting agent and an abrasion resistance improver. Specific additives include a hindered phenolic compound, a hindered amine compound, a sulfur compound, a phosphorus compound, a benzophenone compound, a siloxane modified resin, silicone oil, a fluororesin particle, a polystyrene resin particle, a polyethylene resin particle, a silica particle, an alumina particle and a boron nitride particle.

An average film thickness of the charge transport layer is preferably 5 μm or more and 50 μm or less, is more preferably 8 μm or more and 40 μm or less, and is particularly preferably 10 μm or more and 30 μm or less.

The charge transport layer can be formed by an operation of: preparing a coating liquid for the charge transport layer, which contains each of the above-mentioned materials and a solvent; forming a coating film of the liquid on the charge generating layer; and drying the coating film. Examples of the solvent to be used in the coating liquid include an alcohol-based solvent, a ketone-based solvent, an ether-based solvent, an ester-based solvent, and an aromatic hydrocarbon-based solvent. Among these solvents, the ether-based solvent or the aromatic hydrocarbon-based solvent is preferable.

(2) Single Layer Type Photosensitive Layer

The single layer type photosensitive layer can be formed by an operation of: preparing a coating liquid for the photosensitive layer, which contains the charge generating substance, the charge transport substance, the resin and a solvent; forming a coating film of the liquid on the undercoat layer; and drying the coating film. The charge generating substance, the charge transport substance and the resin are similar to the examples of the materials in the above described “(1) multilayer type photosensitive layer”.

<Protective Layer>

In the present invention, a protective layer may be provided on the photosensitive layer. By having the protective layer provided thereon, the photosensitive layer can improve its durability.

The protective layer can contain an electro-conductive particle and/or a charge transport substance, and a resin.

The electro-conductive particles include particles of metal oxides such as titanium oxide, zinc oxide, tin oxide and indium oxide.

The charge transport substances include a polycyclic aromatic compound, a heterocyclic compound, a hydrazone compound, a styryl compound, an enamine compound, a benzidine compound, a triarylamine compound, and resins having a group derived from these substances. Among the substances, the triarylamine compound and the benzidine compound are preferable.

The resins include a polyester resin, an acrylic resin, a phenoxy resin, a polycarbonate resin, a polystyrene resin, a phenolic resin, a melamine resin and an epoxy resin. Among the resins, the polycarbonate resin, the polyester resin and the acrylic resin are preferable.

In addition, the protective layer may be formed as a cured film, by polymerizing a composition containing a monomer having a polymerizable functional group. Reactions at this time include a thermal polymerization reaction, a photopolymerization reaction and a radiation polymerization reaction. Examples of the polymerizable functional group which the monomer having the polymerizable functional group has include an acrylic group and a methacrylic group. A material having charge transportability may also be used as the monomer having the polymerizable functional group.

The protective layer may contain additives such as an antioxidant, an ultraviolet absorber, a plasticizer, a leveling agent, a lubricity imparting agent and an abrasion resistance improver. Specific additives include a hindered phenolic compound, a hindered amine compound, a sulfur compound, a phosphorus compound, a benzophenone compound, a siloxane modified resin, silicone oil, a fluororesin particle, a polystyrene resin particle, a polyethylene resin particle, a silica particle, an alumina particle and a boron nitride particle.

An average film thickness of the protective layer is preferably 0.5 μm or more and 10 μm or less, and is more preferably 1 μm or more and 7 μm or less.

The protective layer can be formed by an operation of: preparing a coating liquid for the protective layer, which contains each of the above-mentioned materials and a solvent; forming a coating film of the liquid on the photosensitive layer: and drying and/or curing the coating film. Examples of the solvent to be used for the coating liquid include an alcohol-based solvent, a ketone-based solvent, an ether-based solvent, a sulfoxide-based solvent, an ester-based solvent and an aromatic hydrocarbon-based solvent.

<Surface Processing of Electrophotographic Photosensitive Member>

In the present invention, surface processing of the electrophotographic photosensitive member may be carried out. By the surface processing being carried out, a behavior of a cleaning unit (cleaning blade) can be more stabilized which is contacted with the electrophotographic photosensitive member. Methods of surface processing include: a method of contact-pressing a mold having convex portions with the surface of the electrophotographic photosensitive member, and transferring the shape to the surface; and a method of imparting concave and convex shapes by mechanical polishing. From the viewpoint of the purpose of more stabilizing the behavior of the cleaning unit which is contacted with the electrophotographic photosensitive member, it is more preferable to provide concave portions or convex portions on a surface layer of the electrophotographic photosensitive member.

The above described concave portion or convex portion may be formed on the whole area of the surface of the electrophotographic photosensitive member, or may be formed on a part of the surface of the electrophotographic photosensitive member. In the case where the concave portions or convex portions are formed on a part of the surface of the electrophotographic photosensitive member, it is preferable that the concave portions or convex portions are formed at least in the whole area of the contact area with the cleaning unit (cleaning blade).

In the case where the concave portions are formed, the concave portions can be formed on the surface of the electrophotographic photosensitive member, by an operation of: contact-pressing a mold having the convex portions corresponding to the concave portions with the surface of the electrophotographic photosensitive member; and transferring the shapes to the surface.

<Method for Forming Concave Portion on Circumferential Face of Electrophotographic Photosensitive Member>

The concave portions can be formed on a circumferential face of the electrophotographic photosensitive member, by an operation of: contact-pressing a mold having the convex portions corresponding to the concave portions to be formed with the circumferential face of the electrophotographic photosensitive member; and transferring the shapes to the circumferential face.

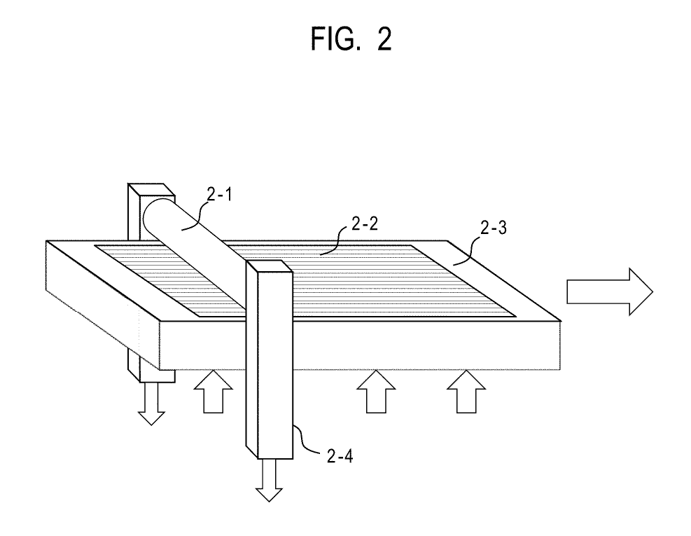

FIG. 2 illustrates an example of a pressure contact shape transfer processing apparatus for forming the concave portions on the circumferential face of the electrophotographic photosensitive member.

The pressure contact shape transfer processing apparatus illustrated in FIG. 2 can form concave portions and flat portions on the circumferential face of the electrophotographic photosensitive member 2-1, by continuously contacting a mold 2-2 with the circumferential face, while rotating the electrophotographic photosensitive member 2-1 which is a work piece, and applying a pressure to the mold 2-2.

Materials of a pressure member 2-3 include metal, metal oxide, plastic and glass. Among the materials, stainless steel (SUS) is preferable, from the viewpoint of mechanical strength, dimensional precision and durability. The pressure member 2-3 has the mold 2-2 installed on its upper face. In addition, a support member (unillustrated) and a pressure system (unillustrated) which are installed on the lower face side can contact the mold 2-2 with the circumferential face of the electrophotographic photosensitive member 2-1 which is supported by a support member 2-4, at a predetermined pressure. In addition, the pressure system may press the support member 2-4 against the pressure member 2-3 at a predetermined pressure, or may press the support member 2-4 and the pressure member 2-3 against each other.

The example illustrated in FIG. 2 is an example in which the pressure member 2-3 is moved in a direction perpendicular to the axial direction of the electrophotographic photosensitive member 2-1, and thereby while the electrophotographic photosensitive member 2-1 drivingly rotates or drivenly rotates, the circumferential face is continuously processed. Furthermore, the circumferential face of the electrophotographic photosensitive member 2-1 can be continuously processed, also by fixing the pressure member 2-3 and moving the support member 2-4 in a direction perpendicular to the axial direction of the electrophotographic photosensitive member 2-1, or also by moving both of the support member 2-4 and the pressure member 2-3.

Incidentally, from the viewpoint of efficiently transferring the shape, the mold 2-2 and the electrophotographic photosensitive member 2-1 can be heated.

Examples of the mold 2-2 include: a metal and a resin film which have been subjected to fine surface processing; a silicon wafer and the like of which the surfaces have been subjected to patterning by a resist; a resin film in which fine particles are dispersed; and a resin film having a fine surface shape which has been subjected to metal coating.

In addition, an elastic body can be installed between the mold 2-2 and the pressure member 2-3, from the viewpoint of making the pressure uniform at which the mold 2-2 is pressed against the electrophotographic photosensitive member 2-1.

The concave portion, the flat portion, the convex portion and the like on the circumferential face of the electrophotographic photosensitive member can be observed, for instance, with the use of a microscope such as a laser microscope, an optical microscope, an electron microscope and an atomic force microscope.

As for the laser microscope, for instance, the following equipment can be used:

Super-depth shape measuring microscope VK-8550, super-depth shape measuring microscope VK-9000, and super-depth shape measuring microscope VK-9500, VK-X200 and VK-X100 which are all manufactured by Keyence Corporation; Scanning type confocal laser microscope OLS 3000 which is manufactured by Olympus Corporation; and

Real color confocal microscope Oprytex C130 which is manufactured by Lasertec Corporation.

As for the optical microscope, for instance, the following equipment can be used:

Digital microscope VHX-500 and Digital microscope VHX-200 which are manufactured by Keyence Corporation; and 3D digital microscope VC-7700 which is manufactured by Omron Corporation.

As for the electron microscope, for instance, the following equipment can be used:

3D real surface view microscope VE-9800 and 3D real surface view microscope VE-8800 which are manufactured by Keyence Corporation;
Scanning type electron microscope conventional/variable pressure SEM which is manufactured by SII NanoTechnology Inc.; and
Scanning type electron microscope SUPERSCAN SS-550 which is manufactured by Shimadzu Corporation.

As for the atomic force microscope, for instance, the following equipment can be used:

Nanoscale hybrid microscope VN-8000 which is manufactured by Keyence Corporation;
Scanning type probe microscope NanoNavi station which is manufactured by SII NanoTechnology Inc.; and
Scanning type probe microscope SPM-9600 which is manufactured by Shimadzu Corporation.

A method for observing the concave portion on the circumferential face of the electrophotographic photosensitive member will be described below.

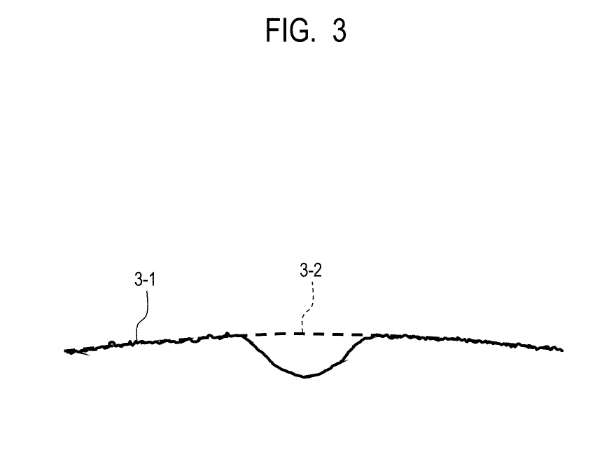

Firstly, the circumferential face of the electrophotographic photosensitive member is magnified and observed with a microscope. Because the circumferential face of the electrophotographic photosensitive member is a curved surface which is bent in the circumferential direction, a cross-sectional profile of the curved surface is extracted, and a curve (circular arc) is fitted. FIG. 3 illustrates an example of the fitting. The example illustrated in FIG. 3 is an example in the case where the electrophotographic photosensitive member has a cylindrical shape. In FIG. 3, a solid line 3-1 is a cross-sectional profile of the circumferential face (curved surface) of the electrophotographic photosensitive member, and a broken line 3-2 is a curve which has been fitted to the cross-sectional profile 3-1. The cross-sectional profile 3-1 is corrected so that the curve 3-2 becomes a straight line, and a surface obtained by extending the obtained straight line in the longitudinal direction (direction orthogonal to circumferential direction) of the electrophotographic photosensitive member is determined to be a reference surface. Also in the case where the electrophotographic photosensitive member is not the cylindrical shape, the reference surface is obtained in a similar way to the case of the cylindrical shape.

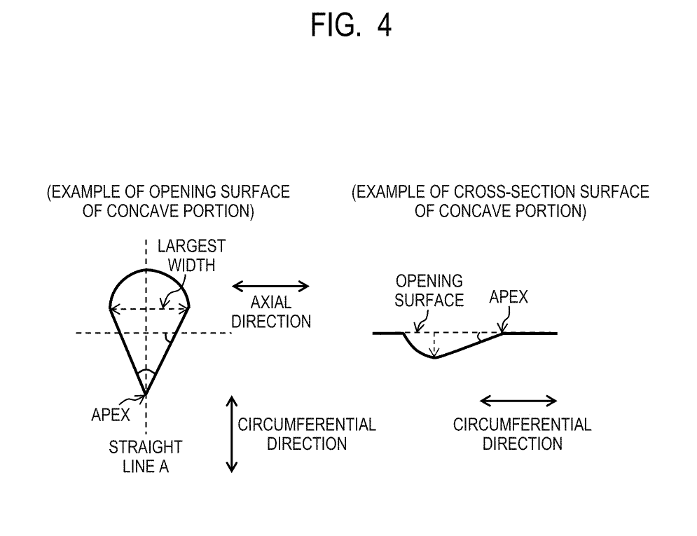

FIG. 4 illustrates an example of an opening surface of the concave portion which has been formed on the circumferential face of the electrophotographic photosensitive member, and an example of a cross section when viewed from the circumferential direction. Incidentally, the example of the cross section of the concave portion in FIG. 4 is a cross-sectional profile after the above described correction.

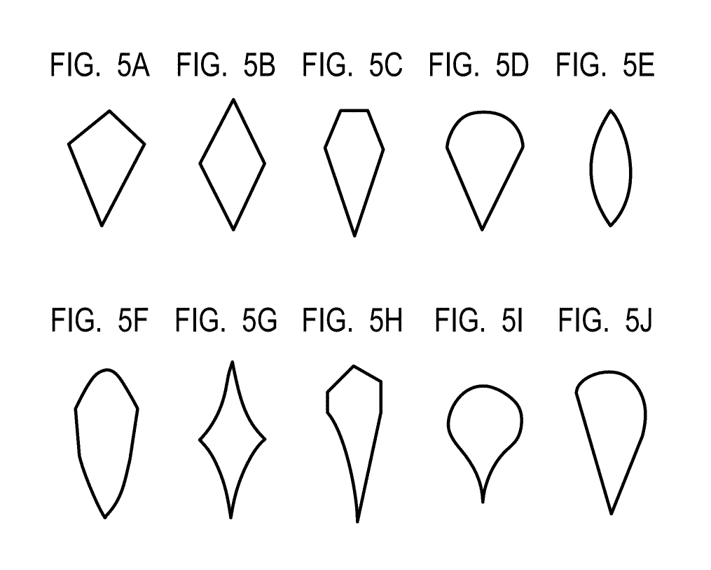

FIGS. 5A to 5J illustrate examples of the shapes of the openings of the concave portions (shapes when concave portions are viewed from above).

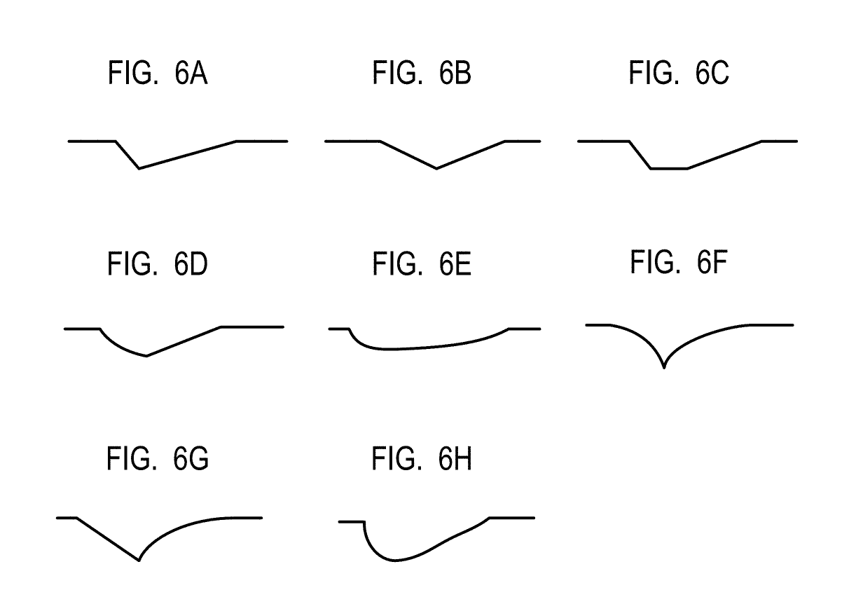

FIGS. 6A to 6H illustrate examples of the shapes of the cross sections of the concave portions when viewed from the circumferential direction.

<Polishing Tool Used for Mechanical Polishing>

Mechanical polishing can be conducted using well-known units. Generally, a polishing tool is allowed to abut on an electrophotographic photosensitive member, and the surface of an electrophotographic photosensitive member is polished by moving either or both relatively. A polishing tool is a polishing member including a layer in which polishing abrasive grains are dispersed in a binder resin on a base material.

Examples of the abrasive grains include particles such as an aluminum oxide, chromium oxide, diamond, iron oxide, cerium oxide, corundum, silica stone, silicon nitride, boron nitride, molybdenum carbide, silicon carbide, tungsten carbide, titanium carbide and silicon oxide. The particle sizes of the abrasive grains are preferably 0.01 to 50 μm, and further more preferably 1 to 15 μm. When the particle sizes of the abrasive grains are too small, polishing force becomes weak, and it becomes difficult that the F/C ratio of the outermost surface of the electrophotographic photosensitive member is increased. These abrasive grains can be used alone or as a mixture of two or more. When two or more are mixed, the two or more may be different or the same in material or particle size.

As the binder resin used for the polishing tool and dispersing the abrasive grain, well-known thermoplastic resins, thermosetting resins, reactive resins, electron beam curing resins, ultraviolet curing resins, visible light curing resins and antifungal resins can be used. Examples of the thermoplastic resins include a vinyl chloride resin, polyamide resins, polyester resins, polycarbonate resins, amino resins, a styrene butadiene copolymer, urethane elastomers and polyamide-silicone resins. Examples of the thermosetting resins include a phenolic resin, phenoxy resins, epoxy resins, polyurethane resins, polyester resins, silicone resins, a melamine resin and alkyd resins. A curing agent of an isocyanate may be added to the thermoplastic resins.

The film thickness of the layer with the abrasive grains dispersed in the binder resin of a polishing tool can be 1 to 100 μm. When the film thickness is too thick, the unevenness of the film thickness easily occurs, and consequently the unevenness of the surface roughness of the object to be polished becomes a problem. Meanwhile, when the film thickness is too thin, it becomes easy that abrasive grains come off.

The shape of the base material of the polishing tool is not particularly limited. In the embodiment of this example, the sheet-shaped base material was used to polish a cylindrical electrophotographic photosensitive member efficiently, but the shape may be another shape. (Hereinafter, the polishing tool of this example is also described as a polishing sheet.) The material the base material of the polishing tool is not particularly limited, either. Examples of the material of the sheet-shaped base material include paper, woven fabrics, nonwoven fabrics and plastic films.

The polishing tool can be obtained by coating the base material with a coating material obtained by mixing and dispersing the above-mentioned abrasive grains and binder resin, and a solvent that can dissolve the binder resin, followed by drying.

<Polishing Apparatus>

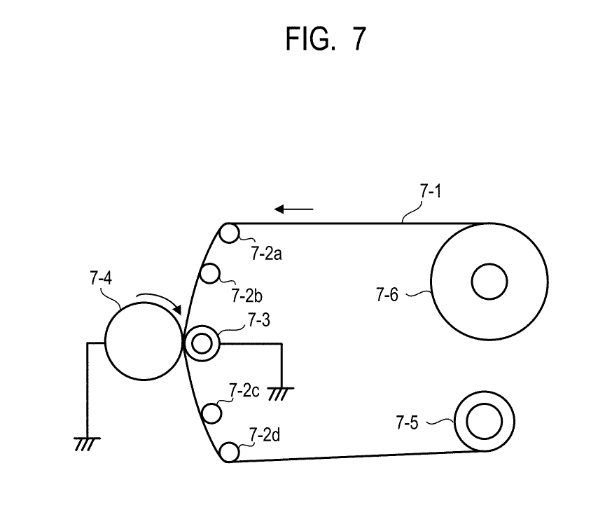

An example of the polish apparatus of the electrophotographic photosensitive member of this example is illustrated in FIG. 7.

FIG. 7 is an apparatus for polishing a cylindrical electrophotographic photosensitive member using a polishing sheet. In FIG. 7, a polishing sheet 7-1 is wound around a hollow shaft 7-6, and a motor (not illustrated) is disposed so that tension is given to the polishing sheet 7-1 in a direction opposite to the direction in which the polishing sheet 7-1 is fed to the shaft 7-6. The polishing sheet 7-1 is fed in the direction of an arrow, and passes a backup roller 7-3 through guide rollers 7-2a and 7-2b, and the polishing sheet 7-1 after polishing is wound around a winding unit 7-5 through guide rollers 7-2c and 7-2d by a motor (not illustrated). Polishing is conducted by always pressure-contacting the polishing sheet 7-1 with a body 7-4 to be processed (electrophotographic photosensitive member before polishing). Since the polishing sheet 7-1 is electrically insulating in many cases, materials that are grounded or have electro-conductivity can be used at portions that contact the polishing sheet 7-1.

The feeding speed of the polishing sheet 7-1 can be in the range of 10 to 1000 mm/min. When the amount of feeding is little, the binder resin adheres to the surface of the polishing sheet 7-1, and this may cause the surface of the body 7-4 to be processed to deeply crack.

The body 7-4 to be processed is opposed to the backup roller 7-3 through the polishing sheet 7-1. In view of improving the evenness of the surface roughness of the body 7-4 to be processed, the backup roller 7-3 can be an elastic body. At this time, the backup roller 7-3 are pressed against the body 7-4 to be processed through the polishing sheet 7-1 at a desired set point for a predetermined period of time, and the surface of the body 7-4 to be processed is polished. The rotation direction of the body 7-4 to be processed may be the same as the feeding direction of the polishing sheet 7-1, and may be opposite to the feeding direction of the polishing sheet 7-1. The rotation direction may be changed during polishing.

Although the pressing pressure of the backup roller 7-3 against the body 7-4 to be processed depends on the hardness of the backup roller 7-3 and the polishing time, the pressing pressure can be 0.005 to 15 N/m².

The surface roughness of the electrophotographic photosensitive member can be adjusted by properly selecting the feeding speed of the polishing sheet 7-1, the pressing pressure of the backup roller 7-3, the abrasive grain type of the polishing sheet, the film thickness of the binder resin of the polishing sheet, the thickness of the base material and the like.

<Measurement of Maximum Height Rmax in JIS B0601'1982>

The surface roughness of the electrophotographic photosensitive member can be measured by well-known units. The surface roughness can be measured using a surface roughness meter such as the surface roughness meter Surf Coder SE3500 of Kosaka Laboratory Ltd., or a microscope such as the non-contact three-dimensional surface measurement machine Micromap 557N of Ryoka Systems Inc. or the super-depth shape measuring microscope VK-8550 or VK-9000 of KEYENCE CORPORATION that can acquire three-dimensional shapes.

In this example, the maximum height Rmax in JIS B0601'1982 prescribed by Japanese Industrial Standards JIS among the indices of surface roughness is used as the polishing depth L In this example, the Rmax is beforehand measured in the range of the section 5 mm square of the electrophotographic photosensitive member cut as a sample of X-ray photoelectron spectroscopy mentioned below. The measurement is conducted at any three points in the range of a 5 mm square, and the average value is adopted as a polishing depth L (μm).

<Process Cartridge and Electrophotographic Apparatus>

A process cartridge of the present invention is characterized by integrally supporting the electrophotographic photosensitive member described so far and at least one unit selected from the group consisting of a charging unit, a developing unit, a transfer unit and a cleaning unit and being detachably attachable to the main body of an electrophotographic apparatus.

The electrophotographic apparatus of the present invention is characterized by having the electrophotographic photosensitive member described so far, the charging unit, an exposing unit, the developing unit, and the transfer unit.

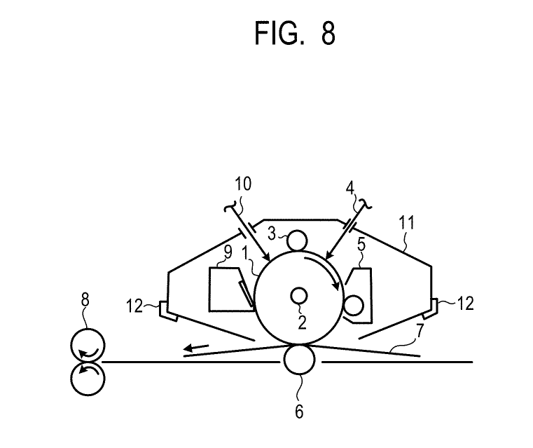

An example of the schematic constitution of an electrophotographic apparatus having the process cartridge including the electrophotographic photosensitive member is illustrated in FIG. 8.

Reference numeral 1 is a cylindrical (drum-shaped) electrophotographic photosensitive member, and is rotated by driving around a shaft 2 in an arrow direction at a predetermined circumferential speed (process speed). The surface of the electrophotographic photosensitive member 1 is charged at a positive or negative predetermined potential by a charging unit 3 in a rotation process. In the figure, although the roller charging process by the roller-shaped charging member is illustrated, a charging process such as corona-charging, proximity charging or injection charging may be adopted. The surface of the charged electrophotographic photosensitive member 1 is irradiated with exposing light 4 from an exposing unit (not illustrated), and an electrostatic latent image corresponding to target image information is formed. The exposing light 4 is light on which intensity modulation is performed by corresponding to time series electric digital image signals of the target picture information, and, for example, is output from an image exposing unit such as slit exposure or laser beam scanning exposure. The electrostatic latent image formed on the surface of the electrophotographic photosensitive member 1 is developed (normally developed or reversely developed) with toner stored in a developing unit 5 to form a toner image on the surface of the electrophotographic photosensitive member 1. The toner image formed on the surface of electrophotographic photosensitive member 1 is transferred to a transfer material 7 by a transfer unit 6. At this time, the bias voltage having reverse polarity to a charge that the toner has is applied from a bias power supply (not illustrated) to the transfer unit 6. When the transfer material 7 is paper, the transfer material 7 is taken out of a paper-feeding part (not illustrated) and fed between the electrophotographic photosensitive member 1 and the transfer unit 6 in synchronization with the rotation of electrophotographic photosensitive member 1. The transfer material 7 to which a toner image was transferred from the electrophotographic photosensitive member 1 is separated from the surface of the electrophotographic photosensitive member 1, conveyed to a fixation unit 8, and printed out of the electrophotographic apparatus as an image-formed material (a print or a copy) by being subjected to the fixation treatment of a toner image. The electrophotographic apparatus may have a cleaning unit 9 for removing deposit such as toner remaining on the surface of the electrophotographic photosensitive member 1 after transfer. A so-called cleanerless system, which removes the above-mentioned deposit by a developing unit or the like without being provided with a cleaning unit separately, may be used. In the present invention, a plurality of components among components selected from the above-mentioned electrophotographic photosensitive member 1, charging unit 3, developing unit 5, transfer unit 6, cleaning unit 9 and the like are placed in a container, and integrally supported to form a process cartridge, which can be configured as to be detachably attachable to the main body of the electrophotographic apparatus. For example, the process cartridge is configured as follows. At least one selected from the charging unit 3, the developing unit 5 and the cleaning unit 9 is integrally supported with the electrophotographic photosensitive member 1, and packed into a cartridge. The cartridge can be formed into a process cartridge 11 that is detachably attachable to the main body of an electrophotographic apparatus using guide units 12 such as the rails of the main body of the electrophotographic apparatus. The electrophotographic apparatus may have an antistatic mechanism that conducts destaticizing processing of the surface of the electrophotographic photosensitive member 1 by pre-exposing light 10 from a pre-exposing unit (not illustrated). The electrophotographic apparatus may be provided with the guide units 12 such as rails for attaching and detaching the process cartridge of the present invention to and from the main body of an electrophotographic apparatus.

The electrophotographic photosensitive member of the present invention can be used for laser beam printers, LED printers, copying machines, facsimiles, multifunctional machines thereof and the like.

### EXAMPLE

The present invention will be described still more specifically using Examples and Comparative Examples hereinafter. The present invention is not limited at all by the following Examples as long as the gist is not exceeded. In the description of the following Examples, “part” is based on mass unless otherwise specified.

### Example 1

<Manufacturing of Electrophotographic Photosensitive Member Before Surface Shape Formation>

Support

As a support (electro-conductive support), a cylindrical aluminum cylinder (JIS-A3003, aluminum alloy, 30 mm in diameter, 357.5 mm in length, 0.7 mm in thickness) having the surface thereof subjected to cutting processing under the following conditions was used.

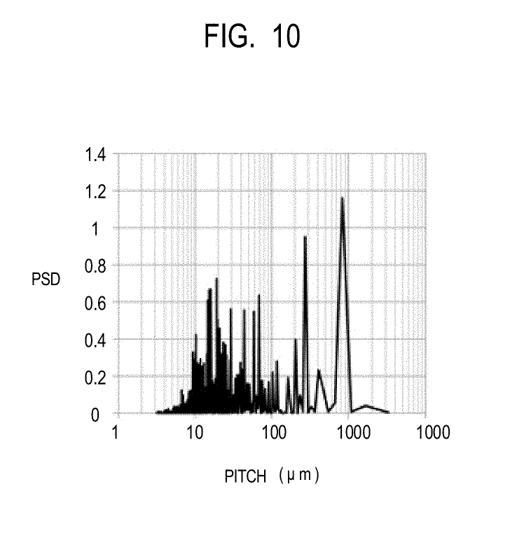

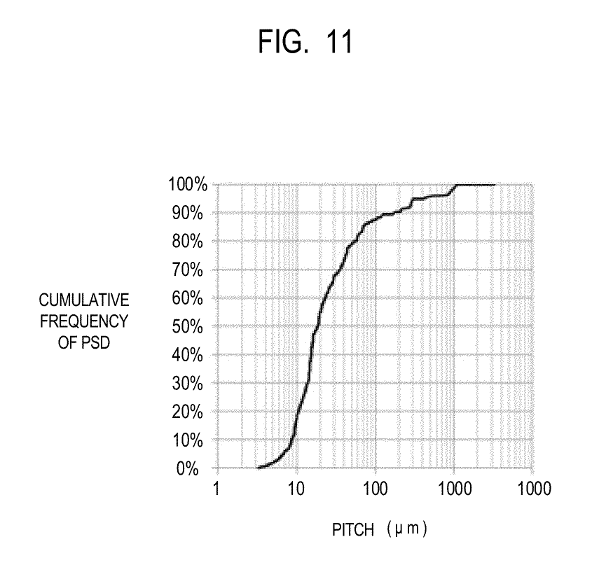

The cutting conditions are that a cutting tool of R0.1 was used, the number of the rotation of the main shaft=10000 rpm, and the feeding speed of the cutting tool was continuously changed in the range of 0.03 to 0.06 mm/rpm. The surface roughness of the manufactured substrate was measured by a surface roughness meter SE700 manufactured by Kosaka Laboratory Ltd. The measurement was conducted under conditions that the cutoff value was 0.8 mm, the measured length was 4 mm, and the data interval was 1.6 μm. The root mean square gradient RΔq determined by JIS B 0601:2001 from the measured roughness curve was determined. According to the following Expression (2), fast Fourier transform was performed on data from a measurement start to the 2048th data as to data of the roughness curve, and FIG. 10 was obtained from the power spectrum derived from Expression (3). The relative cumulative frequency distribution of FIG. 11 was derived from the power spectrum of FIG. 10, and the coefficient of determination was derived as to data of 10% to 50% from Expression (4). A pitch at which the cumulative frequency was 90% was also determined.

$$\begin{matrix}{X}_{k} = {\sum }_{n = 0}^{N - 1} {x}_{n} exp ( - i 2 π kn / N ) & Expression ( 2 ) \\ {P}_{k} = \frac{1}{N Δ T} {\vert {X}_{k} \vert}^{2} & Expression ( 3 ) \\ {R}^{2} = 1 - \frac{{\sum }_{i = 1}^{n} {( {y}_{i} - f ( {x}_{i} ) )}^{2}}{{\sum }_{i = 1}^{n} {( {y}_{i} - μ Y )}^{2}} & Expression ( 4 )\end{matrix}$$

The aluminum cylinder that was subjected to surface processing as mentioned above was used as the support of an electrophotographic photosensitive member.
Formation of Undercoat Layer

Next, 100 parts of an aluminum oxide particle (average primary particle size: 13 nm, specific surface area: 99 m²/g) were mixed with 500 parts of toluene by stirring. Then, 0.71 parts of octyltriethoxysilane (trade name: KBE3083, manufactured by Shin-Etsu Chemical Co., Ltd.) was added to the mixture. The mixture was stirred for 6 hours.

Then, toluene was removed by vacuum distillation. The mixture was dried by heating at 140° C. for 6 hours to obtain a surface-treated aluminum oxide particle M1. The amounts used for surface treatment of the aluminum oxide particle M1 X, X×n and A/B are as described in Table 1.

Next, 15 parts of a butyral (trade name: BM-1, manufactured by SEKISUI CHEMICAL CO., LTD.) as a polyol, and 15 parts of blocked isocyanate (trade name: Sumidule 3175, manufactured by Sumika Covestro Urethane Co., Ltd. (former: Sumitomo Bayer Urethane Co., Ltd.), non-volatile matter content: 75%, blocking agent: oxime) were dissolved in a mixed solvent of 90 parts of methyl ethyl ketone and 90 parts of 1-butanol. Then, 54 parts of the surface-treated aluminum oxide particle M1 and 0.28 parts of 2,3,4-trihydroxybenzophenone (manufactured by Wako Pure Chemical Industries, Ltd.) were added to this solution and dispersed by a sand mill apparatus using glass beads having a diameter of 0.8 mm in an atmosphere at 23±3° C. for 3 hours.

After dispersion treatment, 0.01 parts of silicone oil (trade name: SH28PA, manufactured by Dow Corning Toray Co., Ltd (former: Dow Corning Toray Silicone Co., Ltd.)) was added thereto, and the mixture was stirred to prepare a coating liquid for an undercoat layer.

An undercoat layer having a film thickness of 1.2 μm was formed by coating the above-mentioned support with the obtained coating liquid for undercoat layer by immersion to form a coating film and drying the coat film at 160° C. for 30 minutes.

Formation of Charge Generating Layer

Next, 4 parts of a hydroxy gallium phthalocyanine crystal (charge generating substance) in a crystal form having strong peaks at Bragg angles 2θ±0.2° of 7.4° and 28.1° in CuKα characteristic X-ray diffraction and 0.04 parts of a compound represented by the following Structural Formula (A) were added to a liquid in which 2 parts of polyvinyl butyral (trade name: S-LEC BX-1, manufactured by SEKISUI CHEMICAL CO., LTD.) was dissolved in 100 parts of cyclohexanone. Then, a coating liquid for a charge generating layers was prepared by subjecting the mixture to dispersion treatment by the sand mill using glass beads having a diameter of 1 mm in an atmosphere at 23±3° C. for 1 hour and adding 100 parts of ethyl acetate after dispersion treatment.

A charge generating layer having a film thickness of 0.15 μM was formed by coating the undercoat layer with this coating liquid for a charge generating layer by immersion and drying the obtained coating film at 90° C. for 10 minutes.

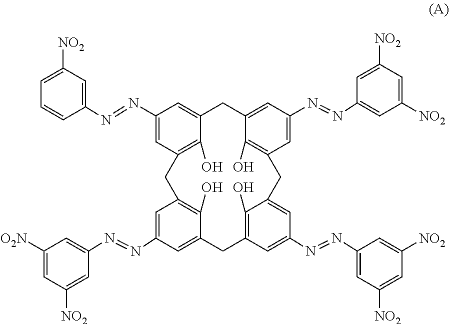 [SMILES: O=[N+]([O-])c1cccc(/N=N/c2cc3c(O)c(c2)Cc2cc(/N=N/c4cc([N+](=O)[O-])cc([N+](=O)[O-])c4)cc(c2O)Cc2cc(/N=N/c4cc([N+](=O)[O-])cc([N+](=O)[O-])c4)cc(c2O)Cc2cc(/N=N/c4cc([N+](=O)[O-])cc([N+](=O)[O-])c4)cc(c2O)C3)c1]

Formation of Charge Transportation Layer

Next, a coating liquid for a charge transport layer was prepared by dissolving 60 parts of a compound represented by the following Structural Formula (B), 30 parts of a compound represented by the following Structural Formula (C), 10 parts of a compound represented by the following Structural Formula (D), 100 parts of a bisphenol Z polycarbonate resin (trade name: Iupilon Z400, manufactured by Mitsubishi Engineering-Plastics Corporation) and 0.2 parts of a polycarbonate (viscosity average molecular weight Mv: 20000) having a structure unit represented by the following Formula (E) in a mixed solvent of 272 parts of o-xylene, 256 parts of methyl benzoate and 272 parts of dimethoxymethane.

A charge transport layer having a film thickness of 18 μm was formed by coating the charge generating layer with this coating liquid for a charge transport layer by immersion to form a coating film and drying the obtained coating film at 115° C. for 50 minutes.

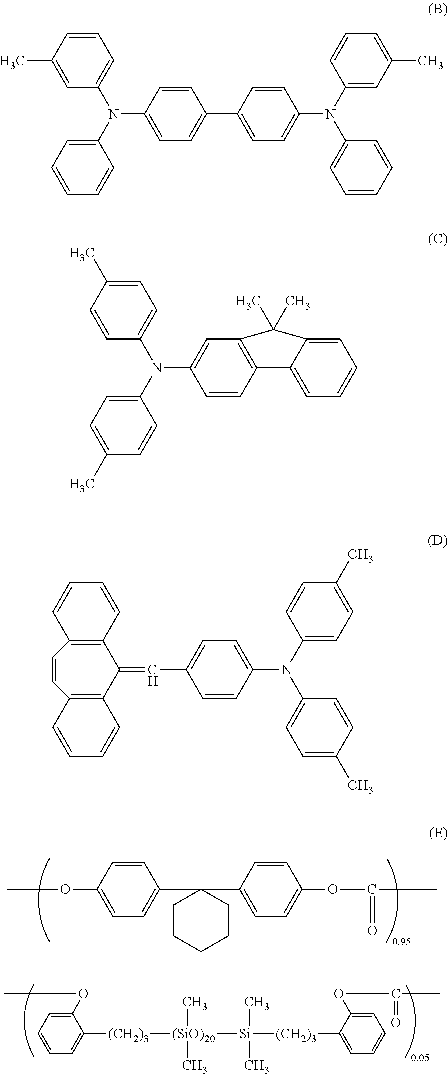

(0.95 and 0.05 are the molar ratio (copolymerization ratio) of two structure units in Formula (E).)

Formation of Protective Layer

Next, 95 parts of a compound represented by the following Structural Formula (F), 5 parts of a vinyl ester compound (manufactured by Tokyo Chemical Industry Co., Ltd.) that is a compounds represented by the following Formula (G), 3.5 parts of a siloxane-modified acrylic compound (BYK-3550, manufactured by BYK Japan KK), 5 parts of a urea compound represented by the following Formula (H), 200 parts of 1-propanol, 100 parts of 1,1,2,2,3,3,4-heptafluorocyclopentane (trade name: ZEORORA H, manufactured by Zeon Corporation) were mixed and stirred. A coating liquid for a surface layer (coating liquid for a protective layer) was prepared by then filtering this solution by a polyflon filter (trade name: PF-020, manufactured by Advantec Toyo Kaisha, Ltd.).

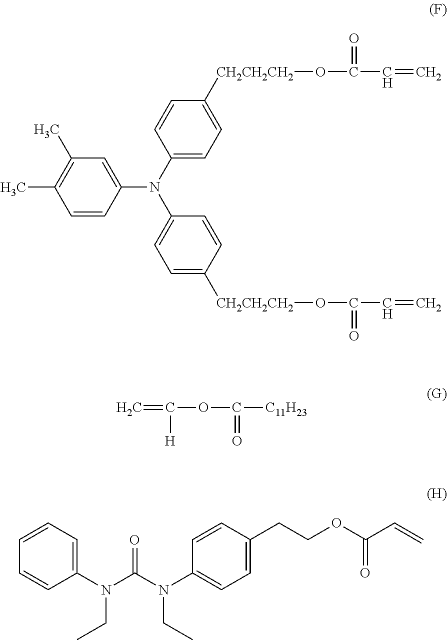

The charge transport layer was coated with this coating liquid for a surface layer by immersion to form a coating film. The obtained coating film was dried at 50° C. for 10 minutes. Then, the coating film was irradiated with an electron beam for 1.6 seconds in a nitrogen atmosphere under the conditions that the accelerating voltage was 70 kV and the beam current was 5.0 mA with a support (object to be irradiated) rotated at speed of 200 rpm. When the absorbed dose of the electron beam at this time was measured, the absorbed dose was 15 kGy. Then, the coating film was heated by raising the temperature over 30 seconds in a nitrogen atmosphere until the temperature of the coating film reached 117° C. from 25° C. The oxygen concentration from electron beam irradiation to subsequent heat treatment was 15 ppm or less. Next, the coating film was naturally cooled in the air atmosphere until the temperature of the coating film reached 25° C. Heat treatment was performed for 30 minutes under the condition that the temperature of the coating film became 105° C. to form a protective layer (surface layer) having a film thickness of 5 μm.

Thus, an electrophotographic photosensitive member before surface shape formation that had a protective layer was produced.

<Surface Processing Example 1 of Electrophotographic Photosensitive Member>

Formation of Concave Portions by Mold Pressure Contact Shape Transfer

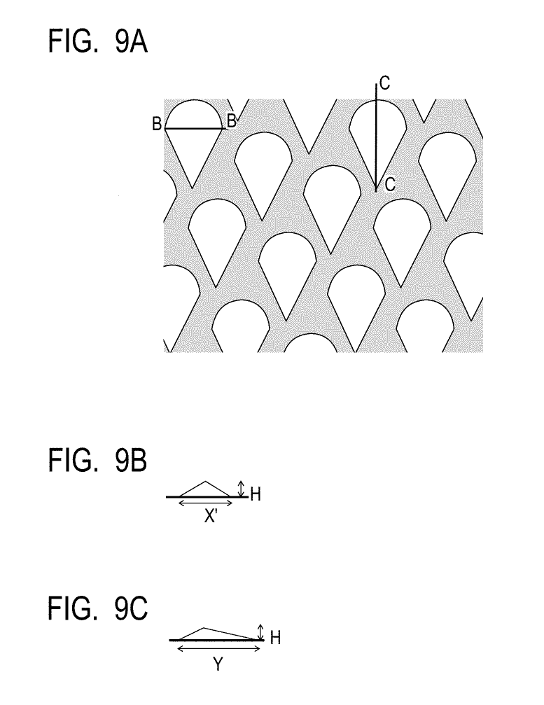

A pressure contact shape transfer processing apparatus having a configuration that was roughly illustrated in FIG. 2 was provided with a mold having a shape that was roughly illustrated in FIGS. 9A to 9C (in this example, convex portions having a maximum width (means a maximum width in the axial direction when a convex portion on the mold is viewed from the top, and will mean the same hereinafter) X′: 30 μm, a maximum length (means the maximum length in a circumferential direction when the convex portion on the mold is viewed from the top, and will mean the same hereinafter) Y: 75 μm, the rate of area 60%, and a height H: 1.0 μm). The circumferential face of the manufactured electrophotographic photosensitive member before concave portion formation was then processed by the apparatus. Concave portions were formed on the whole area of the circumferential face of an electrophotographic photosensitive member by controlling the temperatures of the electrophotographic photosensitive member and the mold during processing so that the temperature of the circumferential face of the electrophotographic photosensitive member was 120° C. and rotating the electrophotographic photosensitive member in a circumferential direction with the pressure member pressured against the electrophotographic photosensitive member at a pressure of 7.0 MPa.

Thus, the electrophotographic photosensitive member having concave portions on the circumferential face was manufactured.

Observation of Circumferential Face of Electrophotographic Photosensitive Member

The circumferential face of the obtained electrophotographic photosensitive member was observed by magnification by a lens with a magnifying power of 50 by a laser microscope (manufactured by KEYENCE CORPORATION, trade name: X-100). Concave portions provided on the circumferential face of the electrophotographic photosensitive member were determined. At the time of observation, adjustment was conducted so that no inclination existed in the longitudinal direction of the electrophotographic photosensitive member and the apex of the arc of the electrophotographic photosensitive member was brought into focus as to the peripheral direction. Regions 500 μm square were observed, and images observed by magnification were connected by an image connection application to obtain a magnified observation image. Filter processing was performed on the obtained result with the filter type median by selecting the image processing height data by attached image analysis software.

The depth of the concave portion, the width in the axial direction of an opening, the length of the opening in the circumferential direction, the area, the angle of the apex (intersection) formed by two straight lines, and the like were determined by the above-mentioned observation. Results are illustrated below.

### Width of Opening in Axial Direction X′: 30 μm

### Length of Opening in Circumferential Direction Y: 75 μm

### Area: 150000 μm²

### Shape Depth: 0.5 μm

Angles Formed by Two Lines Extending to Apex and Straight Line in Axial Direction: 76 degrees

### Angle of Apex: 28°

Angle Formed by Straight Line Drawn from Deepest Point to Apex and Opening: 0.5°

When the circumferential face of the electrophotographic photosensitive member was observed by the same method as mentioned above using another laser microscope (manufactured by KEYENCE CORPORATION, trade name: X-9500), the same results as the case where the above-mentioned laser microscope (manufactured by KEYENCE CORPORATION, trade name: X-100) were used was obtained.

Thus, the electrophotographic photosensitive member that had a support, an undercoat layer, a charge generating layer, a charge transport layer and a protection layer and on which the surface shape was further formed was manufactured.

### Example 2

First, 100 parts of an aluminum oxide particle (average primary particle size: 10 nm, specific surface area: 130 m²/g) and 500 parts of toluene were mixed by stirring. Then, 0.54 parts of octyltriethoxysilane (trade name: KBE3083, manufactured by Shin-Etsu Chemical Co., Ltd.) was added to the mixture. The mixture was stirred for 6 hours.

Then, toluene was removed by vacuum distillation. The mixture was dried by heating at 140° C. for 6 hours to obtain a surface-treated aluminum oxide particle M2. The amounts used for surface treatment of the aluminum oxide particle M2 X, X×n and A/B are as described in Table 1.

An electrophotographic photosensitive member was manufactured in the same way as in Example 1 except that an undercoat layer coating liquid was prepared by changing the aluminum oxide particle M1 into the aluminum oxide particle M2 in Example 1.

### Example 3

First, 100 parts of an aluminum oxide particle (average primary particle size: 10 nm, specific surface area: 80 m²/g) and 500 parts of toluene were mixed by stirring. Then, 0.14 parts of octyltriethoxysilane (trade name: KBE3083, manufactured by Shin-Etsu Chemical Co., Ltd.) was added to the mixture. The mixture was stirred for 6 hours.

Then, toluene was removed by vacuum distillation. The mixture was dried by heating at 140° C. for 6 hours to obtain a surface-treated aluminum oxide particle M3. The amounts used for surface treatment of the aluminum oxide particle M3 X, X×n and A/B are as described in Table 1.

An electrophotographic photosensitive member was manufactured in the same way as in Example 1 except that an undercoat layer coating liquid was prepared by changing the aluminum oxide particle M1 into the aluminum oxide particle M3 in Example 1.

### Example 4

First, 100 parts of an aluminum oxide particle (average primary particle size: 10 nm, specific surface area: 150 m²/g) and 500 parts of toluene were mixed by stirring. Then, 1.03 parts of octyltriethoxysilane (trade name: KBE3083, manufactured by Shin-Etsu Chemical Co., Ltd.) was added to the mixture. The mixture was stirred for 6 hours.

Then, toluene was removed by vacuum distillation. The mixture was dried by heating at 140° C. for 6 hours to obtain a surface-treated aluminum oxide particle M4. The amounts used for surface treatment of the aluminum oxide particle M4 X, X×n and A/B are as described in Table 1.

An electrophotographic photosensitive member was manufactured in the same way as in Example 1 except that an undercoat layer coating liquid was prepared by changing the aluminum oxide particle M1 into the aluminum oxide particle M4 in Example 1.

### Example 5

First, 100 parts of an aluminum oxide particle (average primary particle size: 18 nm, specific surface area: 65 m²/g) and 500 parts of toluene were mixed by stirring. Then, 2.17 parts of octyltriethoxysilane (trade name: KBE3083, manufactured by Shin-Etsu Chemical Co., Ltd.) was added to the mixture. The mixture was stirred for 6 hours.

Then, toluene was removed by vacuum distillation. The mixture was dried by heating at 140° C. for 6 hours to obtain a surface-treated aluminum oxide particle M5. The amounts used for surface treatment of the aluminum oxide particle M5 X, X×n and A/B are as described in Table 1.

An electrophotographic photosensitive member was manufactured in the same way as in Example 1 except that an undercoat layer coating liquid was prepared by changing the aluminum oxide particle M1 into the aluminum oxide particle M5 in Example 1.

### Example 6

First, 100 parts of an aluminum oxide particle (average primary particle size: 13 nm, specific surface area: 99 m²/g) and 500 parts of toluene were mixed by stirring. Then, 0.14 parts of octyltriethoxysilane (trade name: KBE3083, manufactured by Shin-Etsu Chemical Co., Ltd.) was added to the mixture. The mixture was stirred for 6 hours.

Then, toluene was removed by vacuum distillation. The mixture was dried by heating at 140° C. for 6 hours to obtain a surface-treated aluminum oxide particle M6. The amounts used for surface treatment of the aluminum oxide particle M6 X, X×n and A/B are as described in Table 1.

An electrophotographic photosensitive member was manufactured in the same way as in Example 1 except that an undercoat layer coating liquid was prepared by changing the aluminum oxide particle M1 into the aluminum oxide particle M6 in Example 1.

### Example 7

First, 100 parts of an aluminum oxide particle (average primary particle size: 13 nm, specific surface area: 99 m²/g) and 500 parts of toluene were mixed by stirring. Then, 1.42 parts of octyltriethoxysilane (trade name: KBE3083, manufactured by Shin-Etsu Chemical Co., Ltd.) was added to the mixture. The mixture was stirred for 6 hours.

Then, toluene was removed by vacuum distillation. The mixture was dried by heating at 140° C. for 6 hours to obtain a surface-treated aluminum oxide particle M7. The amounts used for surface treatment of the aluminum oxide particle M7 X, X×n and A/B are as described in Table 1.

An electrophotographic photosensitive member was manufactured in the same way as in Example 1 except that an undercoat layer coating liquid was prepared by changing the aluminum oxide particle M1 into the aluminum oxide particle M7 in Example 1.

### Example 8

First, 100 parts of an aluminum oxide particle (average primary particle size: 13 nm, specific surface area: 99 m²/g) and 500 parts of toluene were mixed by stirring. Then, 0.38 parts of hexyltrimethoxysilane (trade name: KBM3063, manufactured by Shin-Etsu Chemical Co., Ltd.) was added to the mixture. The mixture was stirred for 6 hours.

Then, toluene was removed by vacuum distillation. The mixture was dried by heating at 140° C. for 6 hours to obtain a surface-treated aluminum oxide particle M8. The amounts used for surface treatment of the aluminum oxide particle M8 X, X×n and A/B are as described in Table 1.

An electrophotographic photosensitive member was manufactured in the same way as in Example 1 except that an undercoat layer coating liquid was prepared by changing the aluminum oxide particle M1 into the aluminum oxide particle M8 in Example 1.

### Example 9

First, 100 parts of an aluminum oxide particle (average primary particle size: 13 nm, specific surface area: 99 m²/g) and 500 parts of toluene were mixed by stirring. Then, 0.75 parts of decyltrimethoxysilane (trade name: KBM3103C, manufactured by Shin-Etsu Chemical Co., Ltd.) was added to the mixture. The mixture was stirred for 6 hours.

Then, toluene was removed by vacuum distillation. The mixture was dried by heating at 140° C. for 6 hours to obtain a surface-treated aluminum oxide particle M9. The amounts used for surface treatment of the aluminum oxide particle M9 X, X×n and A/B are as described in Table 1.

An electrophotographic photosensitive member was manufactured in the same way as in Example 1 except that an undercoat layer coating liquid was prepared by changing the aluminum oxide particle M1 into the aluminum oxide particle M9 in Example 1.

### Example 10

First, 100 parts of an aluminum oxide particle (average primary particle size: 13 nm, specific surface area: 99 m²/g) and 500 parts of toluene were mixed by stirring. Then, 0.68 parts of dodecyltrimethoxysilane (trade name: D3383, manufactured by Tokyo Chemical Industry Co., Ltd.) was added to the mixture. The mixture was stirred for 6 hours.

Then, toluene was removed by vacuum distillation. The mixture was dried by heating at 140° C. for 6 hours to obtain a surface-treated aluminum oxide particle M10. The amounts used for surface treatment of the aluminum oxide particle M10 X, X×n and A/B are as described in Table 1.

An electrophotographic photosensitive member was manufactured in the same way as in Example 1 except that an undercoat layer coating liquid was prepared by changing the aluminum oxide particle M1 into the aluminum oxide particle M10 in Example 1.

### Example 11

First, 100 parts of an aluminum oxide particle (average primary particle size: 13 nm, specific surface area: 99 m²/g) and 500 parts of toluene were mixed by stirring. Then, 0.57 parts of hexadecyltrimethoxysilane (trade name: H1376, manufactured by Tokyo Chemical Industry Co., Ltd.) was added to the mixture. The mixture was stirred for 6 hours.

Then, toluene was removed by vacuum distillation. The mixture was dried by heating at 140° C. for 6 hours to obtain a surface-treated aluminum oxide particle M11. The amounts used for surface treatment of the aluminum oxide particle M11 X, X×n and A/B are as described in Table 1.

An electrophotographic photosensitive member was manufactured in the same way as in Example 1 except that an undercoat layer coating liquid was prepared by changing the aluminum oxide particle M1 into the aluminum oxide particle M11 in Example 1.

### Example 12

First, 100 parts of an aluminum oxide particle (average primary particle size: 13 nm, specific surface area: 99 m²/g) and 500 parts of toluene were mixed by stirring. Then, 0.53 parts of octadecyltrimethoxysilane (trade name: O0256, manufactured by Tokyo Chemical Industry Co., Ltd.) was added to the mixture. The mixture was stirred for 6 hours.

Then, toluene was removed by vacuum distillation. The mixture was dried by heating at 140° C. for 6 hours to obtain a surface-treated aluminum oxide particle M12. The amounts used for surface treatment of the aluminum oxide particle M12 X, X×n and A/B are as described in Table 1.

An electrophotographic photosensitive member was manufactured in the same way as in Example 1 except that an undercoat layer coating liquid was prepared by changing the aluminum oxide particle M1 into the aluminum oxide particle M12 in Example 1.

### Example 13

An electrophotographic photosensitive member was manufactured in the same way as in Example 1 except that an undercoat layer having a film thickness of 5 μm was formed in Example 1.

### Example 14

An electrophotographic photosensitive member was manufactured in the same way as in Example 1 except that an undercoat layer having a film thickness of 10 μm was formed in Example 1.

### Example 15

An electrophotographic photosensitive member was manufactured in the same way as in Example 1 except that an undercoat layer having a film thickness of 18 μm was formed in Example 1.

### Example 16

An electrophotographic photosensitive member was manufactured in the same way as in Example 1 except that an undercoat layer having a film thickness of 30 was formed in Example 1.

### Example 17

An electrophotographic photosensitive member was manufactured in the same way as in Example 1 except that 30 parts of an alcohol soluble copolyamide (trade name: AMILAN CM-8000, manufactured by Toray Industries, Inc., nylon 6/66/610/12 copolymer) was used as a binder resin instead of butyral and blocked isocyanate used for preparing a coating liquid for an undercoat layer in Example 1.

### Example 18

An electrophotographic photosensitive member was manufactured in the same way as in Example 1 except that 30 parts of phenol (trade name: Plyophen J-325, manufactured by DIC Corporation (former: Dainippon Ink and Chemicals, Inc.)) was used as a binder resin instead of butyral and blocked isocyanate used for preparing a coating liquid for an undercoat layer in Example 1.

### Example 19

An electrophotographic photosensitive member was manufactured in the same way as in Example 1 except that the amounts of butyral and blocked isocyanate used for preparing a coating liquid for an undercoat layer used were each 21.5 parts in Example 1.

### Example 20

An electrophotographic photosensitive member was manufactured in the same way as in Example 1 except that the amounts of butyral and blocked isocyanate used for preparing a coating liquid for an undercoat layer used were each 7.9 parts in Example 1.

### Example 21

An electrophotographic photosensitive member was manufactured in the same way as in Example 1 except that the mixed solvent used for preparing a coating liquid for an undercoat layer was a mixed solvent of 135 parts of methyl ethyl ketone and 45 parts of 1-butanol in Example 1.

### Example 22

An electrophotographic photosensitive member was manufactured in the same way as in Example 1 except that the mixed solvent used for preparing a coating liquid for an undercoat layer was a mixed solvent of 90 parts of methanol and 90 parts of methoxypropanol in Example 1.

### Example 23

An electrophotographic photosensitive member was manufactured in the same way as in Example 1 except that alizarin (manufactured by Tokyo Chemical Industry Co., Ltd.) 0.28 parts was used in Example 1 instead of 2,3,4-trihydroxybenzophenone as an electron accepting compound used for preparing a coating liquid for an undercoat layer.

### Example 24

An electrophotographic photosensitive member was manufactured in the same way as in Example 1 except that silicone oil was not used in the preparation of a coating liquid for an undercoat layer in Example 1.

### Example 25

An electrophotographic photosensitive member was manufactured in the same way as in Example 1 except that an undercoat layer having a film thickness of 1.2 μm was formed by drying the undercoat layer coating film formed on the support for 50 minutes at 150° C. in Example 1.

### Example 26

An electrophotographic photosensitive member was manufactured in the same way as in Example 1 except that an undercoat layer having a film thickness of 1.2 μm was formed by drying the undercoat layer coating film formed on the support at 170° C. for 20 minutes in Example 1.

### Example 27

An electrophotographic photosensitive member was manufactured in the same way as in Example 1 except that the support was changed into a surface-untreated aluminum cylinder in Example 1.

### Example 28

An electrophotographic photosensitive member was manufactured in the same way as in Example 1 except that a support surface-treated as follows was used.

As a support (electro-conductive support), a cylindrical aluminum cylinder (JIS-A3003, an aluminum alloy, 30 mm in diameter, 357.5 mm in length, 0.7 mm in thickness) the surface of which was subjected to cutting processing under the following conditions was used.

A lathe was equipped with the support, which was subjected to cutting by a diamond-sintered cutting tool so that the outer diameter was 30.0±0.02 mm, the deflection precision was 15 μm, and the surface roughness Rz=0.2 μm. At this time, the number of the rotation of the main shaft was 3000 rpm, the feeding speed of the cutting tool was 0.3 mm/rev, and the processing time was 24 seconds except for the attachment and detachment of the work piece.

The measurement of surface roughness was conducted based on JIS B 0601 using the surface roughness meter Surf Coder SE3500 of Kosaka Laboratory Ltd. at a cutoff of 0.8 mm and a measured length of 8 mm.

Liquid honing processing was performed on the obtained aluminum cut pipe using a liquid (wet) honing apparatus under the following conditions.

(Liquid Honing Conditions)

### Polishing Material Abrasive Grain=Spherical Alumina Beads Having Average Particle Size 30 μm

(Trade Name: CB-A30S, manufactured by Showa Denko K.K.)
Suspension Medium=water

### Polishing Material/Suspension Medium=1/9 (Volume Ratio)

### Number of Rotations of Aluminum Cut Pipe=1.67 S⁻¹

### Air Spraying Pressure=0.15 MPa

Gun movement speed=13.3 mm/sec
Distance between Gun Nozzle and Aluminum Pipe=200 mm
Honing abrasive grain ejection angle=45°
Number of Times of Polishing Liquid Projection=Once (one way)

As to the surface roughness of the cylinder after honing, Rmax was 2.53 μm, Rz was 1.51 μm, Ra was 0.23 μm, and Sm was 34 μm. Immediately after a wet honing process was conducted as mentioned above, the aluminum cylinder was temporarily immersed in pure water in an immersion tank and pulled up. Before the cylinder was dried, pure water shower washing was performed. Then, hot water at 85° C. was ejected from an ejection nozzle to the inner surface of the substrate. The hot water was contacted with the inner surface of the substrate, followed by the drying of the outer surface. Then, the inner surface of the substrate was naturally dried.

The aluminum cylinder surface-treated as above was used as the support of an electrophotographic photosensitive member.

### Example 29

An electrophotographic photosensitive member was manufactured in the same way as in Example 1 except that an electro-conductive layer was provided on the support as follows.

First, 57 parts of a titanium oxide particle having a covering layer (trade name: Passtran LRS, manufactured by MITSUI MINING & SMELTING CO., LTD.), 35 parts of a resol phenolic resin (trade name: Phenolite J-325, manufactured by DIC Corporation (former: Dainippon Ink K.K.), a methanol solution having a solid content of 60%) and 33 parts of 2-methoxy-1-propanol were dispersed by the sand mill using glass beads having a diameter of 1 mm for 3 hours to prepare a dispersion. The average particle size of a powder contained in this dispersion was 0.30 μm. A liquid in which 8 parts of a silicone resin (trade name: Tospearl 120, Momentive Performance Materials Inc. (former: Toshiba Silicones Co., Ltd.)) was dispersed in 8 parts of 2-methoxy 1-propanol was added to this dispersion. Further, 0.008 parts of silicone oil (trade name: SH28PA, manufactured by Dow Corning Toray Co., Ltd. (former: Toray Silicone Co., Ltd.)) was added to the mixture. An electro-conductive layer having a film thickness of 30 μm was formed by coating the above-mentioned aluminum cylinder with the thus prepared dispersion by immersion, heat-hardening this for 30 minutes in the hot air dryer adjusted to 150° C., and hardening a coated film of the dispersion.

### Example 30

An electrophotographic photosensitive member was manufactured in the same way as in Example 1 except that a charge transport layer was formed and a protection layer was not provided as follows.

A coating liquid for a charge transport layer was prepared by dissolving 72 parts of a compound represented by the Structural Formula (B), 8 parts of a compound represented by the Structural Formula (D), 100 parts of a compound represented by the following Structural Formula (I) and 1.8 parts of a compound represented by the following Structural Formula (J) in a mixed solvent of 360 parts of o-xylene, 160 parts of methyl benzoate and 270 parts of dimethoxy methane (methylal).

A charge transport layer having a film thickness of 20 μm was formed by coating the charge generating layer with this coating liquid for a charge transport layer by immersion to form a coating film, and drying the obtained coating film at 125° C. for 50 minutes.

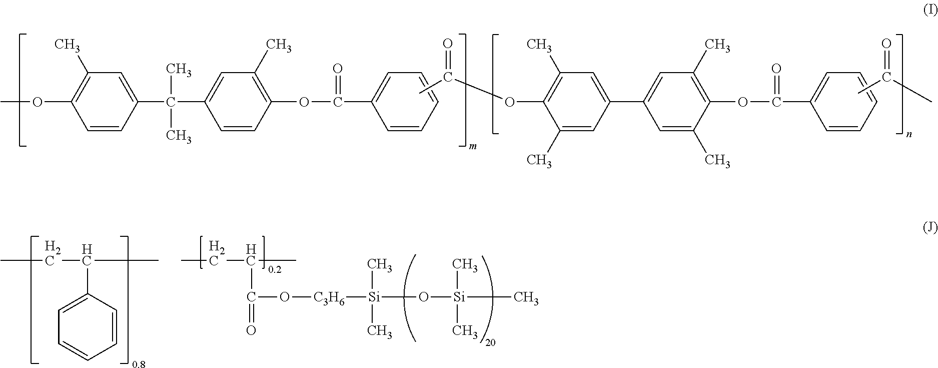

(In Formula (I), m and n represent a copolymerization ratio, and m:n=7:3. In Formula (J), 0.8 and 0.2 represent a copolymerization ratio of two structure units.)

### Example 31

An electrophotographic photosensitive member was manufactured in the same way as in Example 1 except that surface shape formation was performed on an electrophotographic photosensitive member before surface shape formation that has a protective layer by mechanical polish as follows.

<Surface Processing Example 2 of Electrophotographic Photosensitive Member>

Polishing of Electrophotographic Photosensitive Member Before Surface Polishing

The surface of the electrophotographic photosensitive member before surface shape formation was polished. Polishing was performed under the following conditions using the polish apparatus in FIG. 7.

Feeding Speed of Polishing Sheet: 400 mm/min

### Number of Rotation of Electrophotographic Photosensitive Member: 450 rpm

Shoving Electrophotographic Photosensitive Member into Backup Roller: 3.5 mm

### Rotational Direction of Polishing Sheet and Electrophotographic Photosensitive Member:

### With

Backup Roller: 100 mm in Outer Diameters, Asker C hardness 25

A polishing sheet A with which the polishing apparatus was equipped was manufactured by mixing polishing abrasive grains used for the GC3000 and GC2000 of RIKEN CORUNDUM CO., LTD.

### GC3000 (Surface Roughness of Polishing Sheet Ra 0.83 μm)

### GC2000 (Surface Roughness of Polishing Sheet Ra 1.45 μm)

Polishing sheet A (Surface Roughness of Polishing Sheet Ra 1.12 μm)
Time of polishing using the polishing sheet A was 20 seconds.

Measurement of Polishing Depth L (μm)

As to the electrophotographic photosensitive member after polishing, the maximum height Rmax according to JIS B 0601'1982 was measured using the surface roughness meter Surf Coder SE3500 type by Kosaka Laboratory Ltd. Measurement conditions were set as follows. The measurement was conducted at any three points in the range of a 5 mm square, and the average value thereof was adopted as a polishing depth L (μm). The polishing depth L of the electrophotographic photosensitive member after surface polish was 0.75 μm.

(Measurement Conditions)

### Detector: R 2 μm

Sensing Pin: Diamond stylus of 0.7 mN

### Filter: 2CR

### Cutoff Value: 0.08 mm

### Measured Length: 2.5 mm

### Feeding Speed: 0.1 mm

### Example 32

An electrophotographic photosensitive member was manufactured in the same way as in Example 30 except that a surface layer was formed as follows.

A coating liquid for a protection layer was prepared by dispersing and mixing 36 parts of a compounds represented by the following Structural Formula (F) (charge transport substance having acrylic groups, which are chain polymerizable functional group), 4 parts of a polytetrafluoroethylene resin fine powder (Lubron L-2, manufactured by DAIKIN INDUSTRIES, LTD.), and 60 parts of n-propanol by an ultrahigh pressure dispersing machine.

The above-mentioned charge transport layer was coated with this coating liquid for a protective layer by immersion. The obtained coating film was dried at 50° C. for 5 minutes. After drying, the coating film was irradiated with electron beams in a nitrogen atmosphere with the cylinder rotated for 1.6 seconds under the conditions that the accelerating voltage was 70 kV and the absorbed doses was 8000 Gy, followed by the hardening of the coating film. Then, heat treatment was performed in a nitrogen atmosphere for 3 minutes under the condition that the coating film reached 120° C. The concentration of oxygen was 20 ppm from the irradiation with electron beams to 3-minute heat treatment. Next, heat treatment was performed in the air atmosphere for 30 minutes under the conditions the coating film reached 100° C. to form a protective layer (surface layer) having a film thickness of 5 μm.

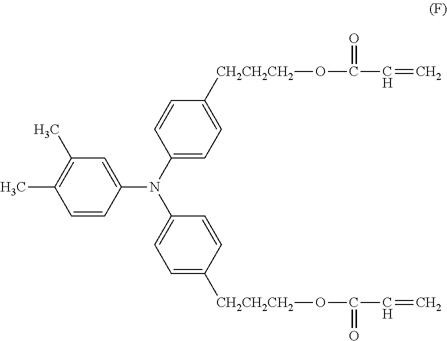

### Comparative Example 1

First, 100 parts of an aluminum oxide particle (average primary particle size: 13 nm, specific surface area: 99 m²/g) and 500 parts of toluene were mixed by stirring. Then, 0.22 parts of isobutyltrimethoxysilane (trade name: Z-2306, manufactured by Dow Corning Toray Co., Ltd.) was added to the mixture. The mixture was stirred for 6 hours.

Then, toluene was removed by vacuum distillation. The mixture was dried by heating at 140° C. for 6 hours to obtain a surface-treated aluminum oxide particle M13. The amounts used for surface treatment of the aluminum oxide particle M13 X, X×n and A/B are as described in Table 1.

An electrophotographic photosensitive member was manufactured in the same way as in Example 1 except that an undercoat layer coating liquid was prepared by changing the aluminum oxide particle M1 into the aluminum oxide particle M13 in Example 1.

### Comparative Example 2

First, 100 parts of an aluminum oxide particle (average primary particle size: 13 nm, specific surface area: 99 m²/g) and 500 parts of toluene were mixed by stirring. Then, 0.19 parts of hexyltrimethoxysilane (trade name: KBM3063, manufactured by Shin-Etsu Chemical Co., Ltd.) was added to the mixture. The mixture was stirred for 6 hours.

Then, toluene was removed by vacuum distillation. The mixture was dried by heating at 140° C. for 6 hours to obtain a surface-treated aluminum oxide particle M14. The amounts used for surface treatment of the aluminum oxide particle M14 X, X×n and A/B are as described in Table 1.

An electrophotographic photosensitive member was manufactured in the same way as in Example 1 except that an undercoat layer coating liquid was prepared by changing the aluminum oxide particle M1 into the aluminum oxide particle M14 in Example 1.

### Comparative Example 3

First, 100 parts of an aluminum oxide particle (average primary particle size: 13 nm, specific surface area: 99 m²/g) and 500 parts of toluene were mixed by stirring. Then, 0.84 parts of octadecyltrimethoxysilane (trade name: O0256, manufactured by Tokyo Chemical Industry Co., Ltd.) was added to the mixture. The mixture was stirred for 6 hours.

Then, toluene was removed by vacuum distillation. The mixture was dried by heating at 140° C. for 6 hours to obtain a surface-treated aluminum oxide particle M15. The amounts used for surface treatment of the aluminum oxide particle M15 X, X×n and A/B are as described in Table 1.

An electrophotographic photosensitive member was manufactured in the same way as in Example 1 except that an undercoat layer coating liquid was prepared by changing the aluminum oxide particle M1 into the aluminum oxide particle M15 in Example 1.

### Comparative Example 4

First, 100 parts of a tin oxide particle (average primary particle size: 20 nm, specific surface area: 75 m²/g) and 500 parts of toluene were mixed by stirring. Then, 0.94 parts of octyltriethoxysilane (trade name: KBE3083, manufactured by Shin-Etsu Chemical Co., Ltd.) was added to the mixture. The mixture was stirred for 6 hours.

Then, toluene was removed by vacuum distillation. The mixture was dried by heating at 140° C. for 6 hours to obtain a surface-treated tin oxide particle N1. The amounts used for surface treatment of the tin oxide particle N1 X, X×n and A/B are as described in Table 1.

An electrophotographic photosensitive member was manufactured in the same way as in Example 1 except that an undercoat layer coating liquid was prepared by changing the aluminum oxide particle M1 into the tin oxide particle N1 in Example 1.

TABLE 1

| | Prescription of undercoat layer | | | | | | |
|---|---|---|---|---|---|---|---|
| | Metal oxide particle | | | | | | |
| | | | Average | Specific | Amount X [% by | | |
| | | | primary | surface | mass] used for | | |
| Number of | | | particle | area B | surface treatment | | |
| example | Material | Name | size [nm] | [m²/g] | of material | Xxn | A/B |
| Example 1 | Aluminum oxide | M1 | 13 | 99 | 8.78 | 70.2 | 0.09 |
| Example 2 | Aluminum oxide | M2 | 10 | 130 | 11.52 | 92.2 | 0.09 |
| Example 3 | Aluminum oxide | M3 | 18 | 65 | 11.52 | 92.2 | 0.18 |
| Example 4 | Aluminum oxide | M4 | 10 | 80 | 1.42 | 11.3 | 0.01 |
| Example 5 | Aluminum oxide | M5 | 10 | 150 | 29.26 | 234.0 | 0.20 |
| Example 6 | Aluminum oxide | M6 | 13 | 99 | 1.76 | 14.0 | 0.02 |
| Example 7 | Aluminum oxide | M7 | 13 | 99 | 17.55 | 140.4 | 0.18 |
| Example 8 | Aluminum oxide | M8 | 13 | 99 | 2.62 | 15.7 | 0.03 |
| Example 9 | Aluminum oxide | M9 | 13 | 99 | 8.33 | 83.3 | 0.08 |
| Example 10 | Aluminum oxide | M10 | 13 | 99 | 9.20 | 110.4 | 0.09 |
| Example 11 | Aluminum oxide | M11 | 13 | 99 | 10.95 | 175.2 | 0.11 |
| Example 12 | Aluminum oxide | M12 | 13 | 99 | 11.84 | 213.2 | 0.12 |
| Example 13 | Aluminum oxide | M1 | 13 | 99 | 8.78 | 70.2 | 0.09 |
| Example 14 | Aluminum oxide | M1 | 13 | 99 | 8.78 | 70.2 | 0.09 |
| Example 15 | Aluminum oxide | M1 | 13 | 99 | 8.78 | 70.2 | 0.09 |
| Example 16 | Aluminum oxide | M1 | 13 | 99 | 8.78 | 70.2 | 0.09 |
| Example 17 | Aluminum oxide | M1 | 13 | 99 | 8.78 | 70.2 | 0.09 |
| Example 18 | Aluminum oxide | M1 | 13 | 99 | 8.78 | 70.2 | 0.09 |
| Example 19 | Aluminum oxide | M1 | 13 | 99 | 8.78 | 70.2 | 0.09 |
| Example 20 | Aluminum oxide | M1 | 13 | 99 | 8.78 | 70.2 | 0.09 |
| Example 21 | Aluminum oxide | M1 | 13 | 99 | 8.78 | 70.2 | 0.09 |
| Example 22 | Aluminum oxide | M1 | 13 | 99 | 8.78 | 70.2 | 0.09 |
| Example 23 | Aluminum oxide | M1 | 13 | 99 | 8.78 | 70.2 | 0.09 |
| Example 24 | Aluminum oxide | M1 | 13 | 99 | 8.78 | 70.2 | 0.09 |
| Example 25 | Aluminum oxide | M1 | 13 | 99 | 8.78 | 70.2 | 0.09 |
| Example 26 | Aluminum oxide | M1 | 13 | 99 | 8.78 | 70.2 | 0.09 |
| Example 27 | Aluminum oxide | M1 | 13 | 99 | 8.78 | 70.2 | 0.09 |
| Example 28 | Aluminum oxide | M1 | 13 | 99 | 8.78 | 70.2 | 0.09 |
| Example 29 | Aluminum oxide | M1 | 13 | 99 | 8.78 | 70.2 | 0.09 |
| Example 30 | Aluminum oxide | M1 | 13 | 99 | 8.78 | 70.2 | 0.09 |
| Example 31 | Aluminum oxide | M1 | 13 | 99 | 8.78 | 70.2 | 0.09 |
| Example 32 | Aluminum oxide | M1 | 13 | 99 | 8.78 | 70.2 | 0.09 |
| Comparative | Aluminum oxide | M13 | 13 | 99 | 1.13 | 4.5 | 0.01 |
| Example 1 | | | | | | | |
| Comparative | Aluminum oxide | M14 | 13 | 99 | 1.31 | 7.9 | 0.01 |
| Example 2 | | | | | | | |
| Comparative | Aluminum oxide | M15 | 13 | 99 | 18.95 | 341.1 | 0.19 |
| Example 3 | | | | | | | |
| Comparative | Tin oxide | N1 | 20 | 75 | 6.65 | 53.2 | 0.09 |
| Example 4 | | | | | | | |

<Evaluation of Electrophotographic Photosensitive Member>

Evaluation apparatuses 1 and 2 illustrated below were equipped with manufactured electrophotographic photosensitive members, and evaluation shown below was performed.

[Evaluation Apparatus 1]

A remodeled machine of a copying machine image RUNNER iR-ADV C5051 manufactured by Canon Inc. (a charging unit was based on a process in which direct current voltage was applied to a roller contact charging member (charging roller), and an exposing unit were based on a laser image exposure process (the wavelength was 780 nm)) was equipped with each of the electrophotographic photosensitive members manufactured in Examples 1 to 32 and Comparative Examples 1 to 4, followed by evaluation.

Specifically, the above-mentioned evaluation apparatus was placed under the conditions that the temperature was 23° C. and the humidity was 50% RH, and a process cartridge for a cyan color was equipped with each of the manufactured electrophotographic photosensitive members, and the station of the process cartridge of cyan was equipped with the process cartridge, followed by evaluation.

As a charging condition, the direct current component (initial dark portion potential (Vda)) applied to a charging roller was −700 V. As an exposure condition, the exposure condition was adjusted so that the initial light portion potential (Vla) before the repeated use in the case of irradiation with laser exposing light was −200 V.

The surface potential of the electrophotographic photosensitive member was measured by removing a cartridge for development from the above-mentioned evaluation apparatus and inserting a potential measuring apparatus there. The potential measuring apparatus includes a potential measuring probe (trade name: model 6000B-8, manufactured by TREK JAPAN KK) at the development position of the cartridge for development. The potential measuring probe was positioned at the center of the direction of the generating line of the electrophotographic photosensitive member, and at a gap of 3 mm from the surface of an electrophotographic photosensitive member as to an electrophotographic photosensitive member. Further, the potential at the central portion of the electrophotographic photosensitive member was measured using a surface potential meter (trade name: model 344, manufactured by TREK JAPAN KK).

[Evaluation Apparatus 2]

A remodeled machine of the copying machine image RUNNER iR-ADV C5051 manufactured by Canon Inc. (the charging unit was based on a process in which voltage obtained by superimposing alternating current voltage on direct current voltage was applied to a roller contact charging member (charging roller), and an exposing unit were based on a laser image exposure process (wavelength was 780 nm)) was equipped with the electrophotographic photosensitive members manufactured in Examples 1, followed by evaluation.

Specifically, the above-mentioned evaluation apparatus was placed under the conditions that the temperature was 23° C. and the humidity was 50% RH, and a process cartridge for a cyan color was equipped with the manufactured electrophotographic photosensitive member, and the station of the process cartridge of cyan was equipped with the process cartridge, followed by evaluation.

As a charging condition, the alternating component applied to the charging roller had a voltage between peaks of 1300V and a frequency of 1300 Hz, and the direct current component (initial dark portion potential (Vda)) applied to a charging roller was −700 V. As an exposure condition, the exposure condition was adjusted so that the initial light portion potential (Vla) before the repeated use in the case of irradiation with laser exposing light was −200V.

The surface potential of the electrophotographic photosensitive member was measured by removing a cartridge for development from the above-mentioned evaluation apparatus and inserting a potential measuring apparatus there. The potential measuring apparatus includes the potential measuring probe (trade name: model 6000B-8, manufactured by TREK JAPAN KK) in the development position of the cartridge for development. The potential measuring probe was positioned at the center of the direction of the generating line of the electrophotographic photosensitive member, and at a gap of 3 mm from the surface of an electrophotographic photosensitive member as to an electrophotographic photosensitive member. Further, the potential at the central portion of the electrophotographic photosensitive member was measured using the surface potential meter (trade name: model 344, manufactured by TREK JAPAN KK).

Evaluation of Fluctuation in Potential at Time of Repeated Use

The cartridges for development equipped with the electrophotographic photosensitive members was attached to the above-mentioned evaluation apparatuses 1 and 2, and the repeated use of the photosensitive members by passing 10000 sheets was conducted. The repeated image formation of 10000 sheets was conducted by printing character images having a printing rate of 1% in monochrome of cyan using plain paper of A4 size. The initial light portion potential at this time is compared with the light portion potential after the repeated image formation of 10000 sheets, and the fluctuation is defined as the value of fluctuation in potential (ΔV1). After the end of passage of sheets of 10000 sheets, the apparatus was left to stand for 5 minutes. The cartridge for development was changed into the potential measuring apparatus, and the light portion potential (Vlb) and the dark portion potential (Vdb) after repeated use were measured. The difference between the light portion potential after repeated use and the initial light portion potential was determined as the amount of fluctuation in the light portion potential (ΔV1=|Vlb|−|Vla|). The difference between the dark portion potential after repeated use and initial dark portion potential was determined as the amount of fluctuation in the dark portion potential (ΔVd=|Vdb|−|Vda|). The amount of fluctuation in the light portion potential and the amount of fluctuation in the dark portion potential were evaluated according to the following evaluation ranking. It was considered that ranks A, B, C and D were levels at which an effect of the present invention was obtained and the rank A was a particularly excellent level in the present invention. Meanwhile, it was considered that a rank E was a level at which an effect of the present invention is not obtained.

A: A case where changes in light portion potential and dark part potential is 5 V or less.
B: A case where changes in light portion potential and dark part potential is more than 5 V and 10 V or less
C: A case where changes in light portion potential and dark part potential is more than 10 V and 20 V or less
D: A case where changes in light portion potential and dark part potential is more than 20 V and 30 V or less
E: A case where changes in light portion potential and dark part potential is more than 30 V

Thus, results obtained by evaluating using the evaluation apparatus 1 were illustrated in Table 2. Results obtained by evaluating using the evaluation apparatus 2 were illustrated in Table 3.

Evaluation of Black Spots at Initial Stage and after Repeated Use

In image evaluation of black spots, images with the whole surface solid in white were output using gloss paper of A4 size, and the numbers of black spots included in the areas of output images that were each equivalent to 1 round of the electrophotographic photosensitive member before and after the passage of 10000 sheets were evaluated by appearance according to the following evaluation ranking. The area that are equivalent to 1 round of the electrophotographic photosensitive member is a rectangular area is 297 mm, which is the longitudinal length of an A4 sheet, in length and 94.2 mm, which is equivalent to 1 round of the electrophotographic photosensitive member, in width. It was considered that ranks A, B, C and D were levels at which an effect of the present invention was obtained and the rank A was a particularly excellent level in the present invention. Meanwhile, it was considered that a rank E was a level at which an effect of the present invention is not obtained.

A: No black spots exist at all.
B: Black spots that are less than 1.5 mm in diameter are 1 or more and 3 or less, and black spots that are 1.5 mm or more in diameter do not exist.
C: Black spots that are less than 1.5 mm in diameter are 1 or more and 3 or less, and black spots that are 1.5 mm or more in diameter are 1 or more and 2 or less.
D: Black spots that are less than 1.5 mm in diameter are 4 or more and 5 or less, and black spots that are 1.5 mm or more in diameter are 2 or less.
E: Black spots that are less than 1.5 mm in diameter are 6 or more, or black spots that are 1.5 mm or more in diameter are 3 or more.

Thus, results obtained by evaluating using the evaluation apparatus 1 were illustrated in Table 2. Results obtained by evaluating using the evaluation apparatus 2 were illustrated in Table 3.

TABLE 2

| | Evaluation using evaluation apparatus 1 | | |
|---|---|---|---|
| | ΔVl after | | Black spot after |
| | passage of | Black spot at | passage of |
| | 10000 sheets | initial stage | 10000 sheets |
| Example 1 | A | A | A |
| Example 2 | B | A | A |
| Example 3 | A | A | A |
| Example 4 | A | A | A |
| Example 5 | B | A | A |
| Example 6 | A | B | C |
| Example 7 | B | A | B |
| Example 8 | A | B | C |
| Example 9 | A | A | A |
| Example 10 | B | A | B |
| Example 11 | C | B | B |
| Example 12 | C | B | B |
| Example 13 | A | A | A |
| Example 14 | B | B | B |
| Example 15 | C | B | C |
| Example 16 | D | C | D |
| Example 17 | C | B | D |
| Example 18 | C | B | D |
| Example 19 | A | A | A |
| Example 20 | C | D | D |
| Example 21 | A | A | A |
| Example 22 | A | A | A |
| Example 23 | A | A | A |
| Example 24 | A | A | A |
| Example 25 | A | A | A |
| Example 26 | A | A | A |
| Example 27 | A | A | A |
| Example 28 | A | A | A |
| Example 29 | A | A | A |
| Example 30 | A | A | A |
| Example 31 | A | A | A |
| Example 32 | A | A | A |
| Comparative Example 1 | C | D | E |
| Comparative Example 2 | D | C | E |
| Comparative Example 3 | E | B | C |
| Comparative Example 4 | E | D | E |

TABLE 3

| | Evaluation using evaluation apparatus 2 | | |
|---|---|---|---|
| | ΔVl after | | Black spot after |
| | passage of | Black spot at | passage of |
| | 10000 sheets | initial stage | 10000 sheets |
| Example 1 | C | C | D |

When the electrophotographic photosensitive member, the process cartridge and the electrophotographic apparatus are an electrophotographic photosensitive member, a process cartridge and an electrophotographic apparatus of the present invention, it is found that good results are obtained as to all of ΔV1 at the time of repeated use, black spots at an initial stage, and black spots after the repeated passage of sheets as illustrated in Table 2. It is found that like Comparative Examples, black spots occur when X×n is smaller than 10, the fluctuation in the potential becomes large when X×n is larger than 330, and therefore the object of the present invention cannot be achieved.

Further, it is found that effects of the present invention are not sufficiently obtained in a process such as the evaluation apparatus 2 in which voltage obtained by superposing alternating current voltage on direct current voltage is applied to a charge member as a charging unit as illustrated in Table 3.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-088712, filed Apr. 27, 2017, which is hereby incorporated by reference herein in its entirety.

What is claimed is:

1. An electrophotographic photosensitive member comprising a support, an undercoat layer and a photosensitive layer in this order, wherein
the undercoat layer contains a binder resin, and an aluminum oxide particle which is surface-treated with a compound represented by the following formula (1), 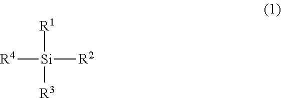
wherein R¹ to R³ each independently represent an alkoxy group or an alkyl group, provided that at least two of R¹ to R³ are alkoxy groups, and R⁴ is an alkyl group having n carbon atoms (6≤n≤18), and wherein
when an amount of aluminum atoms in the surface-treated aluminum oxide particle is represented by M_{Al} and an amount of silicon atoms derived from the compound represented by the formula (1) is represented by M_{Si}, a product of an amount X used for surface treatment defined by X=(M_{Si}/M_{Al})×100 (% by mass) and a number n of carbon atoms in R⁴ (X×n) is 10 or more and 330 or less.

2. The electrophotographic photosensitive member according to claim 1, wherein the X×n is 10 or more and 220 or less.

3. The electrophotographic photosensitive member according to claim 1, wherein
the undercoat layer contains the binder resin and the aluminum oxide particle that is surface-treated with the compound represented by the formula (1), and
when a ratio (% by mass) of a mass of the compound represented by the formula (1) to a mass of the aluminum oxide particle is represented by A and a specific surface area (m²/g) of the aluminum oxide particle is represented by B, an amount A/B used for surface treatment is 0.020 or more and 0.180 or less.

4. The electrophotographic photosensitive member according to claim 1, wherein the n is 6 or more and 12 or less.

5. The electrophotographic photosensitive member according to claim 4, wherein the n is 8.

6. The electrophotographic photosensitive member according to claim 1, wherein a film thickness of the undercoat layer is 0.1 μm or more and 10 μm or less.

7. The electrophotographic photosensitive member according to claim 1, wherein the binder resin is a urethane resin.

8. The electrophotographic photosensitive member according to claim 1, wherein a mass ratio (M_{P}/M_{BR}) of the surface-treated aluminum oxide particle (P) to the binder resin (BR) in the undercoat layer is 1.0/1.0 or more and 3.0/1.0 or less.

9. A process cartridge that integrally supports the electrophotographic photosensitive member and at least one unit selected from the group consisting of a charging unit, a developing unit, a transfer unit and a cleaning unit, and is detachably attachable to a main body of the electrophotographic apparatus, wherein
the electrophotographic photosensitive member comprises a support, an undercoat layer and a photosensitive layer in this order, wherein the undercoat layer contains a binder resin, and an aluminum oxide particle which is surface-treated with a compound represented by the following formula (1), 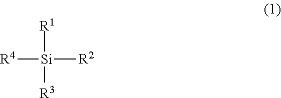
wherein R¹ to R³ each independently represent an alkoxy group or an alkyl group, provided that at least two of R¹ to R³ are alkoxy groups, and R⁴ is an alkyl group having n carbon atoms (6≤n≤18), and wherein
when an amount of aluminum atoms in the surface-treated aluminum oxide particle is represented by M_{Al} and an amount of silicon atoms derived from the compound represented by the formula (1) is represented by M_{Si}, a product of an amount X used for surface treatment defined by X=(M_{Si}/M_{Al})×100 (% by mass) and a number n of carbon atoms in R⁴ (X×n) is 10 or more and 330 or less.

10. An electrophotographic apparatus comprising an electrophotographic photosensitive member, a charging unit, an exposing unit, a developing unit and a transfer unit, wherein
the electrophotographic photosensitive member comprises a support, an undercoat layer and a photosensitive layer in this order, wherein the undercoat layer contains a binder resin, and an aluminum oxide particle which is surface-treated with a compound represented by the following formula (1), 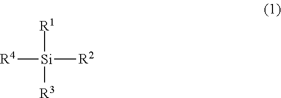
wherein R¹ to R³ each independently represent an alkoxy group or an alkyl group, provided that at least two of R¹ to R³ are alkoxy groups, and R⁴ is an alkyl group having n carbon atoms (6≤n≤18), and wherein
when an amount of aluminum atoms in the surface-treated aluminum oxide particle is represented by M_{Al} and an amount of silicon atoms derived from the compound represented by the formula (1) is represented by M_{Si}, a product of an amount X used for surface treatment defined by X=(M_{Si}/M_{Al})×100 (% by mass) and a number n of carbon atoms in R⁴ (X×n) is 10 or more and 330 or less.

11. The electrophotographic apparatus according to claim 10, comprising a charging roller arranged on the electrophotographic photosensitive member so as to abut on the electrophotographic photosensitive member, and a charging unit which charges the electrophotographic photosensitive member by applying only DC voltage, as the charging unit.
